(19) United States
(12) Patent Application Publication
(10) Pub. No.: US 2024/0137259 A1
(43) Pub. Date: Apr. 25, 2024

(54) FREQUENCY DOMAIN IMBALANCE CORRECTION

(71) Applicant: QUALCOMM Incorporated, San Diego, CA (US)

(72) Inventors: Aviv Regev, Tel Aviv (IL); Ronen Shaked, Kfar Saba (IL)

(21) Appl. No.: 18/049,282

(22) Filed: Oct. 23, 2022

(51) Int. Cl. H04L 27/26; H04B 7/0456; H04L 25/02

(52) U.S. Cl. CPC H04L 27/2657; H04B 7/0456; H04L 25/0224

(57) ABSTRACT

Methods, systems, and devices for wireless communications are described. A user equipment (UE) may receive a reference signal from a network entity. The UE may transmit, to the network entity, an estimation of a frequency domain imbalance between an in-phase portion of the reference signal and a quadrature-phase portion of the reference signal based on a precoding matrix associated with transmissions from the network entity and an estimation of one or more channel conditions between the UE and the network entity. The network entity may perform an imbalance compensation operation that balances the in-phase portion and the quadrature-phase portion of the transmission chain based on the estimation of the frequency domain imbalance. The UE may receive, from the network entity, a data transmission based on transmitting the indication of the estimation of the frequency domain imbalance.

### TECHNICAL FIELD

The following relates to wireless communications, including frequency domain imbalance correction.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a wireless device may operate in a massive multiple-input multiple-output (MIMO) scenario. To operate in such a scenario, a network entity may use many antennas and many modulators to transmit multiple downlink signals to many receiving devices. In some cases, the modulators may be used to transmit both an in-phase portion of a signal and a quadrature-phase portion of the signal. These modulators, however, are subject to an inherent impairment or imbalance (for example, which may be referred to as a frequency domain imbalance) which, in examples in which this is left uncanceled or unaccounted for, may limit link performance of one or both of the wireless device or the network entity, among other issues.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. The method may include receiving, from a network entity, a reference signal, transmitting, to the network entity, an indication of an estimation of a frequency domain imbalance between an in-phase portion of the reference signal and a quadrature-phase portion of the reference signal based on a precoding matrix associated with transmissions from the network entity and an estimation of one or more channel conditions between the UE and the network entity, and receiving, from the network entity, a data transmission based on transmitting the indication of the estimation of the frequency domain imbalance.

Another innovative aspect of the subject matter described in this disclosure can be implemented in an apparatus for wireless communication. The apparatus may include a processor, memory coupled with the processor, and instructions stored in the memory. The instructions may be executable by the processor to cause the apparatus to receive, from a network entity, a reference signal, transmit, to the network entity, an indication of an estimation of a frequency domain imbalance between an in-phase portion of the reference signal and a quadrature-phase portion of the reference signal based on a precoding matrix associated with transmissions from the network entity and an estimation of one or more channel conditions between the UE and the network entity, and receive, from the network entity, a data transmission based on transmitting the indication of the estimation of the frequency domain imbalance.

Another innovative aspect of the subject matter described in this disclosure can be implemented in an apparatus for wireless communication. The apparatus may include means for receiving, from a network entity, a reference signal, means for transmitting, to the network entity, an indication of an estimation of a frequency domain imbalance between an in-phase portion of the reference signal and a quadrature-phase portion of the reference signal based on a precoding matrix associated with transmissions from the network entity and an estimation of one or more channel conditions between the UE and the network entity, and means for receiving, from the network entity, a data transmission based on transmitting the indication of the estimation of the frequency domain imbalance.

Another innovative aspect of the subject matter described in this disclosure can be implemented in a non-transitory computer-readable medium storing code for wireless communication. The code may include instructions executable by a processor to receive, from a network entity, a reference signal, transmit, to the network entity, an indication of an estimation of a frequency domain imbalance between an in-phase portion of the reference signal and a quadrature-phase portion of the reference signal based on a precoding matrix associated with transmissions from the network entity and an estimation of one or more channel conditions between the UE and the network entity, and receive, from the network entity, a data transmission based on transmitting the indication of the estimation of the frequency domain imbalance.

Another innovative aspect of the subject matter described in this disclosure can be implemented in a method for wireless communication. The method may include transmitting, to a UE, a reference signal, receiving an indication of a first estimation of a frequency domain imbalance between an in-phase portion of a transmission chain of the network entity and a quadrature-phase portion of the transmission chain of the network entity, the first estimation being based on the reference signal, a precoding matrix associated with transmissions from the network entity, and an estimation of a channel between the UE and the network entity, performing an imbalance compensation operation associated with the transmission chain of the network entity that balances the in-phase portion and the quadrature-phase portion of the transmission chain based on the first estimation of the frequency domain imbalance, and transmitting, to the UE, a data transmission based on performing the imbalance compensation operation.

Another innovative aspect of the subject matter described in this disclosure can be implemented in an apparatus for wireless communication. The apparatus may include a processor, memory coupled with the processor, and instructions stored in the memory. The instructions may be executable by the processor to cause the apparatus to transmit, to a UE, a reference signal, receive an indication of a first estimation of a frequency domain imbalance between an in-phase portion of a transmission chain of the network entity and a quadrature-phase portion of the transmission chain of the network entity, the first estimation being based on the reference signal, a precoding matrix associated with transmissions from the network entity, and an estimation of a channel between the UE and the network entity, perform an imbalance compensation operation associated with the transmission chain of the network entity that balances the in-phase portion and the quadrature-phase portion of the transmission chain based on the first estimation of the frequency domain imbalance, and transmit, to the UE, a data transmission based on performing the imbalance compensation operation.

Another innovative aspect of the subject matter described in this disclosure can be implemented in an apparatus for wireless communication. The apparatus may include means for transmitting, to a UE, a reference signal, means for receiving an indication of a first estimation of a frequency domain imbalance between an in-phase portion of a transmission chain of the network entity and a quadrature-phase portion of the transmission chain of the network entity, the first estimation being based on the reference signal, a precoding matrix associated with transmissions from the network entity, and an estimation of a channel between the UE and the network entity, means for performing an imbalance compensation operation associated with the transmission chain of the network entity that balances the in-phase portion and the quadrature-phase portion of the transmission chain based on the first estimation of the frequency domain imbalance, and means for transmitting, to the UE, a data transmission based on performing the imbalance compensation operation.

Another innovative aspect of the subject matter described in this disclosure can be implemented in a non-transitory computer-readable medium storing code for wireless communication. The code may include instructions executable by a processor to transmit, to a UE, a reference signal, receive an indication of a first estimation of a frequency domain imbalance between an in-phase portion of a transmission chain of the network entity and a quadrature-phase portion of the transmission chain of the network entity, the first estimation being based on the reference signal, a precoding matrix associated with transmissions from the network entity, and an estimation of a channel between the UE and the network entity, perform an imbalance compensation operation associated with the transmission chain of the network entity that balances the in-phase portion and the quadrature-phase portion of the transmission chain based on the first estimation of the frequency domain imbalance, and transmit, to the UE, a data transmission based on performing the imbalance compensation operation.

### BRIEF DESCRIPTION OF THE DRAWINGS

FIG. 1 illustrates an example of a wireless communications system that supports frequency domain imbalance correction in accordance with one or more examples as disclosed herein.

FIG. 2 illustrates an example of a wireless communications system that supports frequency domain imbalance correction in accordance with one or more examples as disclosed herein.

FIG. 3 illustrates an example of a wireless communications system that supports frequency domain imbalance correction in accordance with one or more examples as disclosed herein.

FIG. 4 illustrates an example of a process flow that supports frequency domain imbalance correction in accordance with one or more examples as disclosed herein.

FIG. 5 illustrates an example of a process flow that supports frequency domain imbalance correction in accordance with one or more examples as disclosed herein.

FIGS. 6 and 7 illustrate block diagrams of devices that support frequency domain imbalance correction in accordance with one or more examples as disclosed herein.

FIG. 8 illustrates a block diagram of a communications manager that supports frequency domain imbalance correction in accordance with one or more examples as disclosed herein.

FIG. 9 illustrates a diagram of a system including a device that supports frequency domain imbalance correction in accordance with one or more examples as disclosed herein.

FIGS. 10 and 11 illustrate block diagrams of devices that support frequency domain imbalance correction in accordance with one or more examples as disclosed herein.

FIG. 12 illustrates a block diagram of a communications manager that supports frequency domain imbalance correction in accordance with one or more examples as disclosed herein.

FIG. 13 illustrates a diagram of a system including a device that supports frequency domain imbalance correction in accordance with one or more examples as disclosed herein.

FIGS. 14 through 16 illustrate flowcharts showing methods that support frequency domain imbalance correction in accordance with one or more examples as disclosed herein.

### DETAILED DESCRIPTION

A network entity may employ a transmission modulator that may modulate an in-phase (I) signal and a quadrature (Q) phase signal (and the modulator may be referred to as an IQ modulator). The IQ modulator may be subject to an inherent impairment or imbalance (which may be referred to as a frequency domain imbalance, an IQ mismatch, or an IQ imbalance) which, if left uncanceled or unaccounted for, may limit link performance, among other issues. For example, such a frequency domain imbalance may include mismatched gains between the I portion and the Q portion of the IQ modulator. As such, in some other different approaches, a network entity may estimate such imbalance and perform compensating actions to correct or cancel the imbalance. However, some wireless communications systems may employ many antennas (for example, in a massive multiple input multiple output (MIMO) scenario) and may employ many IQ modulators, incurring processing burdens, increased complexity, and additional hardware that the network entity may handle to estimate and correct frequency domain imbalances across the various transmission chains used in the massive MIMO scenario.

Various aspects generally relate to correcting frequency domain imbalance, and more specifically, to techniques in which one or more user equipments (UEs) perform estimations of frequency domain imbalance (or mismatch) and transmit such estimations, or information based on the estimations, to the network entity for frequency domain imbalance correction at the network entity. For example, the network entity may transmit a signal, such as a training or a reference signal, to the one or more UEs, and the one or more UEs may estimate the frequency domain imbalance using the signal received through each of multiple respective receiver chains and associated channel conditions. The one or more UEs may then transmit an indication of the frequency domain imbalance estimations to the network entity. The network entity may then use the frequency domain imbalance estimations to perform a correction or cancelation procedure for one or more of its multiple transmission chains, which may reduce or eliminate the frequency domain imbalance for some or all devices, such as the one or more UEs, communicating with the network entity.

Particular aspects of the subject matter described in this disclosure may be implemented to realize one or more of the following potential advantages. A cost and a complexity of network entity operations for correcting or cancelling frequency domain imbalances may be reduced because UEs will estimate the frequency domain imbalances for respective transmission chains, instead of the network entity being burdened with calculating such imbalances for all of its transmission chains. Additionally, the accuracy of frequency domain imbalance estimation may be improved as a result of receiving multiple estimates from multiple UEs derived from transmissions received from a network entity through respective transmission chains and associated channel conditions. Further, other UEs not participating in the mismatch correction procedure may also benefit from the correction performed by the network entity despite the other UEs not having participated in the procedure, as the network entity may perform the correction for transmission chains corresponding to devices, such as the other UEs, that did not contribute a frequency domain imbalance estimation.

Aspects of the disclosure are initially described in the context of wireless communications systems. Aspects of the disclosure are then described with reference to wireless communications systems and process flows. Aspects of the disclosure are further illustrated by and described with reference to apparatus diagrams, system diagrams, and flowcharts that relate to frequency domain imbalance correction.

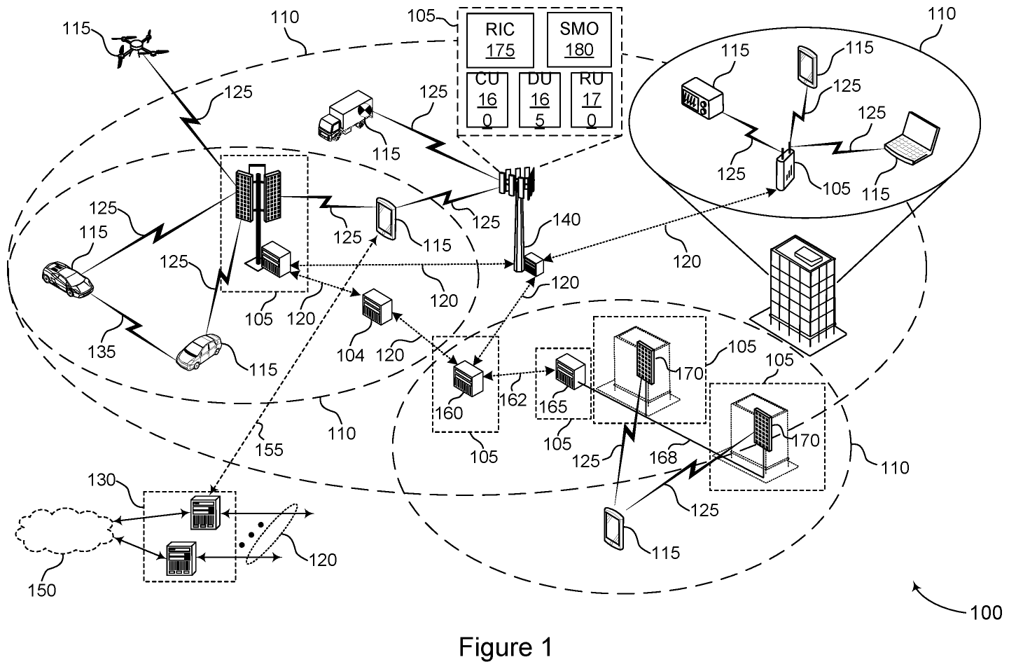

FIG. 1 illustrates an example of a wireless communications system 100 that supports frequency domain imbalance correction in accordance with one or more examples as disclosed herein. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (for example, a radio frequency (RF) access link). For example, a network entity 105 may support a coverage area 110 (for example, a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (for example, any network entity described herein), a UE 115 (for example, any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (for example, in accordance with an S1, N2, N3, or other interface protocol). In some examples, network entities 105 may communicate with one another via a backhaul communication link 120 (for example, in accordance with an X2, Xn, or other interface protocol) either directly (for example, directly between network entities 105) or indirectly (for example, via a core network 130). In some examples, network entities 105 may communicate with one another via a midhaul communication link 162 (for example, in accordance with a midhaul interface protocol) or a fronthaul communication link 168 (for example, in accordance with a fronthaul interface protocol), or any combination thereof. The backhaul communication links 120, midhaul communication links 162, or fronthaul communication links 168 may be or include one or more wired links (for example, an electrical link, an optical fiber link), one or more wireless links (for example, a radio link, a wireless optical link), among other examples or various combinations thereof. A UE 115 may communicate with the core network 130 via a communication link 155.

One or more of the network entities 105 described herein may include or may be referred to as a base station 140 (for example, a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (for example, a base station 140) may be implemented in an aggregated (for example, monolithic, standalone) base station architecture, which may be configured to utilize a protocol stack that is physically or logically integrated within a single network entity 105 (for example, a single RAN node, such as a base station 140).

In some examples, a network entity 105 may be implemented in a disaggregated architecture (for example, a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (for example, a network configuration sponsored by the O-RAN Alliance), or a virtualized RAN (vRAN) (for example, a cloud RAN (C-RAN)). For example, a network entity 105 may include one or more of a central unit (CU) 160, a distributed unit (DU) 165, a radio unit (RU) 170, a RAN Intelligent Controller (RIC) 175 (for example, a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (for example, separate physical locations). In some examples, one or more network entities 105 of a disaggregated RAN architecture may be implemented as virtual units (for example, a virtual CU (VCU), a virtual DU (VDU), a virtual RU (VRU)).

The split of functionality between a CU 160, a DU 165, and an RU 170 is flexible and may support different functionalities depending on which functions (for example, network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (for example, layer 3 (L3), layer 2 (L2)) functionality and signaling (for example, Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (for example, physical (PHY) layer) or L2 (for example, radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (for example, via one or more RUs 170). In some cases, a functional split between a CU 160 and a DU 165, or between a DU 165 and an RU 170 may be within a protocol layer (for example, some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (for example, F1, F1-c, F1-u), and a DU 165 may be connected to one or more RUs 170 via a fronthaul communication link 168 (for example, open fronthaul (FH) interface). In some examples, a midhaul communication link 162 or a fronthaul communication link 168 may be implemented in accordance with an interface (for example, a channel) between layers of a protocol stack supported by respective network entities 105 that are in communication via such communication links.

In wireless communications systems (for example, wireless communications system 100), infrastructure and spectral resources for radio access may support wireless backhaul link capabilities to supplement wired backhaul connections, providing an IAB network architecture (for example, to a core network 130). In some cases, in an IAB network, one or more network entities 105 (for example, IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (for example, a donor base station 140). The one or more donor network entities 105 (for example, IAB donors) may be in communication with one or more additional network entities 105 (for example, IAB nodes 104) via supported access and backhaul links (for example, backhaul communication links 120). IAB nodes 104 may include an IAB mobile termination (IAB-MT) controlled (for example, scheduled) by DUs 165 of a coupled IAB donor. An IAB-MT may include an independent set of antennas for relay of communications with UEs 115, or may share the same antennas (for example, of an RU 170) of an IAB node 104 used for access via the DU 165 of the IAB node 104 (for example, referred to as virtual IAB-MT (vIAB-MT)). In some examples, the IAB nodes 104 may include DUs 165 that support communication links with additional entities (for example, IAB nodes 104, UEs 115) within the relay chain or configuration of the access network (for example, downstream). In such cases, one or more components of the disaggregated RAN architecture (for example, one or more IAB nodes 104 or components of IAB nodes 104) may be configured to operate according to the techniques described herein.

For instance, an access network (AN) or RAN may include communications between access nodes (for example, an IAB donor), IAB nodes 104, and one or more UEs 115. The IAB donor may facilitate connection between the core network 130 and the AN (for example, via a wired or wireless connection to the core network 130). That is, an IAB donor may refer to a RAN node with a wired or wireless connection to core network 130. The IAB donor may include a CU 160 and at least one DU 165 (for example, and RU 170), in which case the CU 160 may communicate with the core network 130 via an interface (for example, a backhaul link). IAB donor and IAB nodes 104 may communicate via an F1 interface according to a protocol that defines signaling messages (for example, an F1 AP protocol). Additionally, or alternatively, the CU 160 may communicate with the core network via an interface, which may be an example of a portion of backhaul link, and may communicate with other CUs 160 (for example, a CU 160 associated with an alternative IAB donor) via an Xn-C interface, which may be an example of a portion of a backhaul link.

An IAB node 104 may refer to a RAN node that provides IAB functionality (for example, access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (for example, an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (for example, DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (for example, a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (for example, transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support frequency domain imbalance correction as described herein. For example, some operations described as being performed by a UE 115 or a network entity 105 (for example, a base station 140) may additionally, or alternatively, be performed by one or more components of the disaggregated RAN architecture (for example, IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (for example, an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (for example, a bandwidth part (BWP)) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (for example, entity, sub-entity) of a network entity 105. For example, the terms “transmitting,” “receiving,” or “communicating,” when referring to a network entity 105, may refer to any portion of a network entity 105 (for example, a base station 140, a CU 160, a DU 165, a RU 170) of a RAN communicating with another device (for example, directly or via one or more other network entities 105).

In some examples, such as in a carrier aggregation configuration, a carrier may also have acquisition signaling or control signaling that coordinates operations for other carriers. A carrier may be associated with a frequency channel (for example, an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (for example, of the same or a different radio access technology).

The communication links 125 shown in the wireless communications system 100 may include downlink transmissions (for example, forward link transmissions) from a network entity 105 to a UE 115, uplink transmissions (for example, return link transmissions) from a UE 115 to a network entity 105, or both, among other configurations of transmissions. Carriers may carry downlink or uplink communications (for example, in an FDD mode) or may be configured to carry downlink and uplink communications (for example, in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (for example, 1.4, 3, 5, 10, 15, 20, 40, or 80 megahertz (MHz)). Devices of the wireless communications system 100 (for example, the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (for example, a sub-band, a BWP) or all of a carrier bandwidth.

Signal waveforms transmitted via a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (for example, a duration of one modulation symbol) and one subcarrier, in which case the symbol period and subcarrier spacing may be inversely related. The quantity of bits carried by each resource element may depend on the modulation scheme (for example, the order of the modulation scheme, the coding rate of the modulation scheme, or both), such that a relatively higher quantity of resource elements (for example, in a transmission duration) and a relatively higher order of a modulation scheme may correspond to a relatively higher rate of communication. A wireless communications resource may refer to a combination of an RF spectrum resource, a time resource, and a spatial resource (for example, a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively-numbered subframes or slots, and each subframe or slot may have the same duration. In some examples, a frame may be divided (for example, in the time domain) into subframes, and each subframe may be further divided into a quantity of slots. Alternatively, each frame may include a variable quantity of slots, and the quantity of slots may depend on subcarrier spacing. Each slot may include a quantity of symbol periods (for example, depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (for example, N f) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some examples, the TTI duration (for example, a quantity of symbol periods in a TTI) may be variable. Additionally, or alternatively, the smallest scheduling unit of the wireless communications system 100 may be dynamically selected (for example, in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a set of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (for example, using a carrier) and may be associated with an identifier for distinguishing neighboring cells (for example, a physical cell identifier (PCID), a virtual cell identifier (VCID), or others). In some examples, a cell also may refer to a coverage area 110 or a portion of a coverage area 110 (for example, a sector) over which the logical communication entity operates. Such cells may range from smaller areas (for example, a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (for example, several kilometers in radius) and may allow unrestricted access by the UEs 115 with service subscriptions with the network provider supporting the macro cell. A small cell may be associated with a lower-powered network entity 105 (for example, a lower-powered base station 140), as compared with a macro cell, and a small cell may operate using the same or different (for example, licensed, unlicensed) frequency bands as macro cells. Small cells may provide unrestricted access to the UEs 115 with service subscriptions with the network provider or may provide restricted access to the UEs 115 having an association with the small cell (for example, the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (for example, MTC, narrowband IoT (NB-IoT), enhanced mobile broadband (eMBB)) that may provide access for different types of devices.

In some examples, a network entity 105 (for example, a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (for example, base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (for example, via Machine-to-Machine (M2M) communication). M2M communication or MTC may refer to data communication technologies that allow devices to communicate with one another or a network entity 105 (for example, a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (for example, a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (for example, according to narrowband communications), or a combination of these techniques. For example, some UEs 115 may be configured for operation using a narrowband protocol type that is associated with a defined portion or range (for example, set of subcarriers or resource blocks (RB s)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (for example, in accordance with a peer-to-peer (P2P), D2D, or sidelink protocol). In some examples, one or more UEs 115 of a group that are performing D2D communications may be within the coverage area 110 of a network entity 105 (for example, a base station 140, an RU 170), which may support aspects of such D2D communications being configured by (for example, scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (for example, UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (for example, network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5 GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (for example, base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (for example, less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (for example, from 30 GHz to 300 GHz), also known as the millimeter band. In some examples, the wireless communications system 100 may support millimeter wave (mmW) communications between the UEs 115 and the network entities 105 (for example, base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (for example, LAA). Operations using unlicensed spectrum may include downlink transmissions, uplink transmissions, P2P transmissions, or D2D transmissions, among other examples.

A network entity 105 (for example, a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (for example, the same codeword) or different data streams (for example, different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (for example, a network entity 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A network entity 105 or a UE 115 may use beam sweeping techniques as part of beamforming operations. For example, a network entity 105 (for example, a base station 140, an RU 170) may use multiple antennas or antenna arrays (for example, antenna panels) to conduct beamforming operations for directional communications with a UE 115. Some signals (for example, synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (for example, by a transmitting device, such as a network entity 105, or by a receiving device, such as a UE 115) a beam direction for later transmission or reception by the network entity 105.

Some signals, such as data signals associated with a particular receiving device, may be transmitted by transmitting device (for example, a transmitting network entity 105, a transmitting UE 115) along a single beam direction (for example, a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (for example, by a network entity 105 or a UE 115) may be performed using multiple beam directions, and the device may use a combination of digital precoding or beamforming to generate a combined beam for transmission (for example, from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted along one or more directions by a network entity 105 (for example, a base station 140, an RU 170), a UE 115 may employ similar techniques for transmitting signals multiple times along different directions (for example, for identifying a beam direction for subsequent transmission or reception by the UE 115) or for transmitting a signal along a single direction (for example, for transmitting data to a receiving device).

A receiving device (for example, a UE 115) may perform reception operations in accordance with multiple receive configurations (for example, directional listening) when receiving various signals from a receiving device (for example, a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (for example, when receiving a data signal). The single receive configuration may be aligned along a beam direction determined based on listening according to different receive configuration directions (for example, a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (for example, a communication link 125, a D2D communication link 135). HARQ may include a combination of error detection (for example, using a cyclic redundancy check (CRC)), forward error correction (FEC), and retransmission (for example, automatic repeat request (ARQ)). HARQ may improve throughput at the MAC layer in poor radio conditions (for example, low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, the UE 115 may receive a reference signal from the network entity 105. The UE may determine an estimation of a frequency domain imbalance between portions of the transmission chain of the network entity 105. The estimation may be based on the reference signal, a precoding matrix associated with transmissions from the network entity, and an estimation of a channel condition between the UE 115 and the network entity 105. The estimation may be generated through an iterative process in which the estimation of the imbalance is compared to the actual imbalance until the difference between the estimation and the actual imbalance satisfies an estimation threshold. The UE 115 may transmit the estimation to the network entity 105 and the network entity 105 may perform an imbalance compensation operation to balance the frequency domain portions of the transmission chain (for example, after the precoder but before the transmission modulator) based on the estimation of the frequency domain imbalance. The UE 115 may receive, from the network entity 105, a data transmission that is transmitted through the corrected or balanced transmission chain of the network entity 105, thereby improving communications between the UE 115 and the network entity 105.

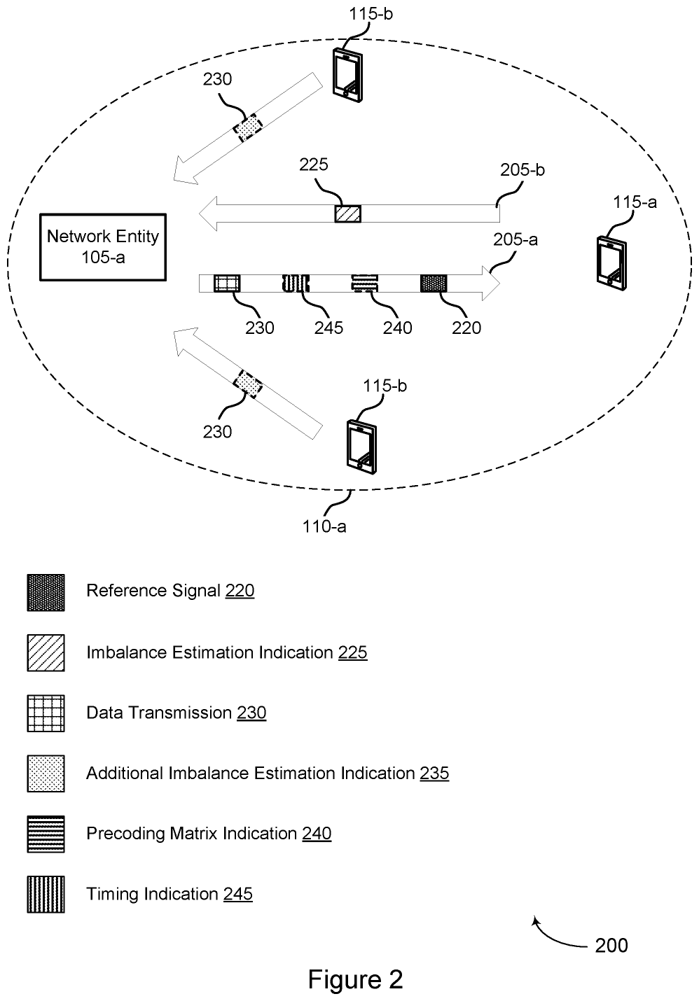

FIG. 2 illustrates an example of a wireless communications system 200 that supports frequency domain imbalance correction in accordance with one or more examples as disclosed herein. The wireless communications system 200 may include the network entity 105-a, which may be an example of one or more network entities discussed in relation to other figures. The wireless communications system 200 may include the UE 115-a and the UE 115-b which may be examples of UEs discussed in relation to other figures.

In some examples, the UE 115-a, the UEs 115-b, or both, may be located in a geographic coverage area 110-a that may be associated with the network entity 105-a. The network entity 105-a and UE 115-a may communicate via one or more downlink communication links 205-a and one or more uplink communication links 205-b.

In some wireless communications systems, a network entity may employ the use of an IQ modulator that modulates an I portion and a Q portion in a transmission chain. Such an IQ modulator may take data to be transmitted (for example, data already processed through a precoder) as an input and may filter an unmodified version of the data with a first FDRSB filter and a modified version of the data (for example, a conjugate version of the data) with a second FDRSB filter. Each filter may include a gain component, a phase component, or both, that may be adjusted by the network entity.

However, a frequency domain imbalance (also referred to as an IQ mismatch, an IQ imbalance, frequency dependent residual side band (FDRSB)) may be an inherent impairment of an IQ modulator (for example, that may be used in a MIMO or massive MIMO scenario). Cancelation, balancing, or correction of the frequency domain imbalance may be desirable because, if left uncanceled, the frequency domain imbalance may limit link performance.

In some implementations involving MIMO or massive MIMO, a network entity may use many antennas fed by many IQ modulators. However, the network entity may perform costly and complex procedures to estimate the numerous frequency domain imbalances present in the many IQ modulators of the many transmission chains used in a MIMO or massive MIMO scenario. Further, the network entity may dedicate hardware for such estimation of frequency domain imbalance of the numerous IQ modulators. Such hardware may include an RF demodulator feedback chain, an analog to digital converter (ADC) for sampling, and hardware for digital frequency domain imbalance estimation.

Further, in higher frequency bands (for example, sub-THz bands) a quantity of transmission chains may increase (for example, as compared to operations in other frequency bands) to reach to a narrow beam which may compensate for path loss (for example, due to high carrier frequency). Therefore, correction of frequency domain imbalances in sub-THz bands for numerous IQ or transmission chains is both advantageous and challenging (for example, due to the large number of parameters to estimate for the numerous IQ or transmission chains).

However, to reduce such costs, a network entity 105-a may instead transmit a training or reference signal 220 to the UE 115-a from which the UE 115-a may digitally estimate the frequency domain imbalance for some or all of the transmission chains of the network entity 105-a, thereby eliminating the need for extra RF hardware at the network entity 105-a. The UE 115-a may transmit the estimation (for example, in an imbalance estimation indication 225) to the network entity 105-a and the network entity 105-a may use the estimation to calculate a correction to be made to one or more transmission chains at the network entity 105-a. The cost and complexity of the network entity 105-a from a frequency domain imbalance correction standpoint is thereby greatly reduced. Further, by having the network entity 105-a perform the correction (for example, instead of each UE applying frequency domain imbalance correction) allows all served UEs (for example, even those that did not contribute a frequency domain imbalance estimation or otherwise contribute to the frequency domain imbalance estimation process) to benefit from the improved communications link (for example, a balanced communications link with a reduced or eliminated frequency domain imbalance).

Thus, the network entity 105-a may correct the frequency domain imbalance at the network entity 105-a rather than at the UE 115-a, thus allowing the network entity 105-a to average the estimation reply from all served UEs (for example, the UE 115-a and the UE 115-b), thereby improving the accuracy of the frequency domain imbalance correction.

In some such approaches, the network entity 105-a may be assisted by one or more connected UEs, such as the UE 115-a and the UE 115-b, to obtain one or more estimations of the frequency domain imbalance. Other UEs that may not be participating in the estimation process may benefit from the correction, even without any estimation process. Such UEs may also enjoy reduced power consumption.

The UE 115-a may estimate the frequency domain imbalance based on the reference signal 220 (for example, a demodulation reference signal (DMRS)), the estimated channel (for example, represented by H), a precoder used at the network entity 105-a (for example, represented by P). However, because such a frequency domain imbalance occurs in an RF domain between the precoder and the IQ modulator (which is located before the channel in the transmission chain), the UE 115-a may perform frequency domain imbalance using knowledge or information about both the channel H and the precoder P individually.

For example, in some approaches, a channel estimation procedure may provide an estimation of H*P. However, in and frequency domain imbalance estimation procedure, the UE 115-a may estimate H alone, rather than H*P. As such, the UE 115-a may receive information associated with the precoder P (for example, through the precoding matrix indication 240) used at the network entity 105-a. Additionally, or alternatively, the network entity 105-a may signal to the UE 115-a that a default, pre-agreed, or a-priori precoder P_{default} may be used. In either case, the UE 115-a receives information about the precoder that the network entity 105-a is using or will use for downlink transmissions to the UE 115-a. Thus, after the network entity 105-a transmits the indication of the precoder to the UE 115-a, and after receiving the frequency domain imbalance estimation from the UE 115-a, the network entity 105-a may apply a correction to the transmission chain (for example, after the precoder and before the IQ modulator) and transmit a signal (for example, the data transmission 230) that has a reduced or eliminated frequency domain imbalance to all its served UEs.

In some examples, the UEs 115-b may also perform one or more estimations of a frequency domain imbalance and may transmit the additional imbalance estimation indications 235 to the network entity 105-a. The network entity 105-a may perform the frequency domain imbalance correction based on some or all of the received frequency domain imbalance estimation indications (for example, by averaging the estimations, optionally including weights for some or all of the estimation indications).

In some examples, the UEs may perform one or more of the operations described herein (for example, the frequency domain imbalance estimation) at a rate or a time specified by the network entity 105-a. For example, the network entity 105-a may transmit a timing indication 245 to the UE 115-a to indicate a schedule, a timing, a point in time, or other timing information to the UE 115-a based on which the UE 115-a may perform the frequency domain imbalance estimation, transmit the imbalance estimation indication 225, or both. By controlling the timing of operations performed by the UE 115-a, the network entity 105-a may be able to track frequency domain imbalance changes over time (for example, due to temperature variation, aging, changing channel conditions, or one or more other factors).

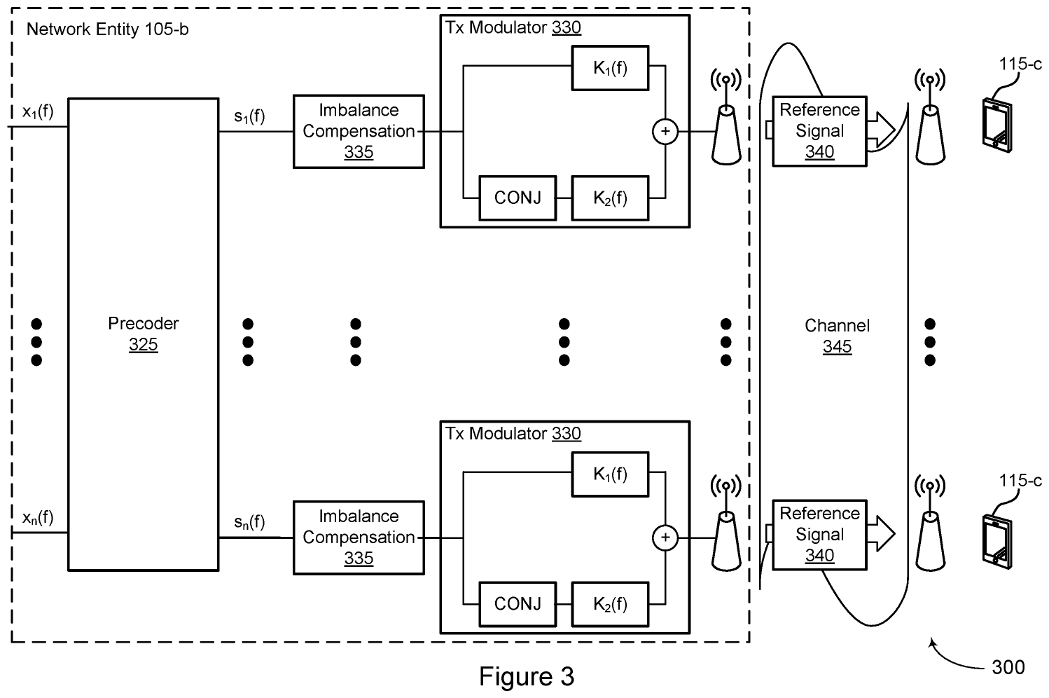

FIG. 3 illustrates an example of a wireless communications system 300 that supports frequency domain imbalance correction in accordance with one or more examples as disclosed herein. The wireless communications system 300 may include the network entity 105-b and one or more UEs 115-c communicating over the channel 345. The network entity 105-a may include a precoder 325, one or more imbalance compensations 335, and one or more transmission (Tx) modulators 330.

The UE 115-c may perform the estimation of the frequency domain imbalance using the reference signal 340 (for example, a DMRS) represented by x, an estimation of the channel 345 represented by H, the precoder 320 represented by P, and the observed signal represented by y. The UE 115-c may reproduce the transmitted signal s̅(f)=P(f)·x̅(f) by using the reference signal 340 and the coefficients of the precoder 320. The UE 115-c may estimate the channel \tilde{H}(f)=H(f)*diag(K₁(f)) using one or more channel estimation methods. The UE 115-c may estimate the frequency domain imbalance, represented by ϕ(f) based at least in part on the estimated channel H and the reproduced transmission signal s.

It should be noted that the channel estimation may similarly suffer from the frequency domain imbalance. As such, the UE 115-c may employ an iterative method for estimating the frequency domain imbalance in which the channel is estimated using the reference signal 340 that is impaired with the frequency domain imbalance, the frequency domain imbalance may be corrected over the reference signal, and the channel estimation may be repeated over the reference signal 340. Such a process may be repeated iteratively to better refine the channel estimation, the frequency domain imbalance estimation, or both.

In some examples, the iterative method may include one or more of the following steps. In an example first step, the UE 115-c may observe the signal received at the UE 115-c, which may be represented by y(f)=\tilde{H}(f)(s(f)+s*(−f)·*ϕ(f))+w(f), in which y(f) represents the received signal, \tilde{H}(f) represents the channel 345, s(f) represents the transmitted data, s*(f) represents the conjugate version of the transmitted data, ϕ(f) represents the frequency domain imbalance, and w(f) represents noise present in the signal.

In an example second step, the UE 115-c may estimate the channel \tilde{H}(f) in which \tilde{H}(f)=H(f)*diag(K₁(f)) using one or more channel estimation methods, in which K₁ is the filter applied at the Tx modulator 330 to the non-conjugate version of the data to be transmitted.

In an example third step, the UE 115-c may estimate the frequency domain imbalance \hat{ϕ}(f). For example, the UE 115-c through a process as described in Equation 1, in which K₁ is the filter applied at the Tx modulator 330 to the non-conjugate version of the data to be transmitted K₂ is the filter applied at the Tx modulator 330 to the conjugate version of the data to be transmitted, and the other elements are as described herein. In some examples, the UE 115-c may estimate the frequency domain imbalance using a least square estimation, a least minimum mean square error estimation, or both. For example, a least square estimation may be represented by \hat{ϕ}_{LS}(f) [U(f)^{H}U(f)]⁻¹U(f)^{H}Q(f) and a least minimum mean square error estimation may be represented by \hat{ϕ}_{LMMSE}(f)=[U(f)^{H}U(f)+σ_{w}²·I]⁻¹U(f)^{H}Q(f).

$$\tilde{H} ( f ) = H ( f ) * diag ( {K}_{1} ( f ) ) \qquad Equation 1$$

$$Φ ( f ) = \frac{{K}_{2} ( f )}{{K}_{1} ( f )} \to$$

$$Q ( f ) {=}^{def} y ( f ) - \tilde{H} ( f ) s ( f ) = \tilde{H} ( f ) {s}^{*} ( - f ) \cdot * Φ ( f ) + w ( f ) \to Q ( f ) = [ \begin{matrix}{\tilde{H}}_{1 , 1} ( f ) & {\tilde{H}}_{1 , 2} ( f ) & … & {\tilde{H}}_{1 , NTx} ( f ) \\ {\tilde{H}}_{2 , 1} ( f ) & {\tilde{H}}_{2 , 2} ( f ) & … & {\tilde{H}}_{2 , NTx} ( f ) \\ ⋮ & ⋮ & ⋮ & ⋮ \\ {\tilde{H}}_{NRx , 1} ( f ) & {\tilde{H}}_{NRx , 1} ( f ) & … & {\tilde{H}}_{NRx , NTx} ( f )\end{matrix} ] diag ( {s}_{1}^{*} ( - f ) {s}_{2}^{*} ( - f ) … {s}_{NTx}^{*} ( - f ) ) [ \begin{matrix}{Φ}_{1} ( f ) \\ {Φ}_{2} ( f ) \\ ⋮ \\ {Φ}_{NTx} ( f )\end{matrix} ] + w ( f )$$

$$Q ( f ) {=}^{def} y ( f ) - \tilde{H} ( f ) s ( f ) = \tilde{H} ( f ) {s}^{*} ( - f ) \cdot * Φ ( f ) + w ( f ) \to Q ( f ) = [ \begin{matrix}{\tilde{H}}_{1 , 1} ( f ) & {\tilde{H}}_{1 , 2} ( f ) & … & {\tilde{H}}_{1 , NTx} ( f ) \\ {\tilde{H}}_{2 , 1} ( f ) & {\tilde{H}}_{2 , 2} ( f ) & … & {\tilde{H}}_{2 , NTx} ( f ) \\ ⋮ & ⋮ & ⋮ & ⋮ \\ {\tilde{H}}_{NRx , 1} ( f ) & {\tilde{H}}_{NRx , 1} ( f ) & … & {\tilde{H}}_{NRx , NTx} ( f )\end{matrix} ] diag ( {s}_{1}^{*} ( - f ) {s}_{2}^{*} ( - f ) … {s}_{NTx}^{*} ( - f ) ) [ \begin{matrix}{Φ}_{1} ( f ) \\ {Φ}_{2} ( f ) \\ ⋮ \\ {Φ}_{NTx} ( f )\end{matrix} ] + w ( f ) {=}^{def} U ( f ) \cdot Φ ( f ) + w ( f )$$

In an example fourth step, the UE 115-c may subtract s*(−f)·*\hat{ϕ}(f) from y(f): giving \tilde{y}(f)=\tilde{H}(f)(s(f)+s*(−f)·*(ϕ(f)−\hat{ϕ}(f)))+w(f).

In an example fifth step, the UE 115-c may determine whether a different between the frequency domain imbalance and the frequency domain imbalance estimation satisfies an estimation threshold. For example, expressed as an equation, the UE 115-c may determine whether ||ϕ(f)−\hat{ϕ}(f)||>TH, in which TH represents the threshold, ϕ(f) represents the frequency domain imbalance and \hat{ϕ}(f) represents the frequency domain imbalance estimation.

If the difference does not satisfy the threshold, the process may be iterated again. If, however, the difference does satisfy the threshold (for example, the difference is less than the threshold), then the process may end (for example, because the frequency domain imbalance estimation is close enough to the actual frequency domain imbalance to be used in for the frequency domain imbalance correction at the network entity 105-b).

The UE 115-c may transmit one or more frequency domain imbalance coefficients to the network entity 105-b to indicate the frequency domain imbalance estimation. In some examples, the frequency domain imbalance coefficients may be sent with a resolution. For example, instead of transmitting a complete set of coefficients, (for example, 4096 coefficients), the UE 115-c may transmit an average of \hat{ϕ}(f) (for example, a selection of coefficients, such as every 50, 100, or 200 coefficients, or another selection of coefficients). The network entity 105-c may interpolate the received coefficients to recover the complete set of coefficients.

In some examples, the network entity 105-b may receive frequency domain imbalance estimations from multiple UEs 115-c and may average them together. In some examples, the network entity 105-b may employ a weighted average, assigning a weight to each estimation based on one or more factors, including differing channel conditions. In some such cases, the UEs 115-c may transmit a channel quality metric or measurement (for example, a signal to noise ratio (SNR)) to the network entity 105-b to aid in the weighting process at the network entity 105-b.

$${s}_{corrected} ( f ) = ( {s}_{i} ( f ) - \hat{ϕ} ( f ) {s}^{*} ( - f ) ) * \frac{1}{1 - {\hat{ϕ}}_{i} ( f ) {\hat{ϕ}}_{i}^{*} ( - f )}$$

The network entity 105-b may apply an imbalance compensation 335 to one or more transmission chains used by the network entity 105-b that may be based on the one or more received frequency domain imbalance estimations. In some examples, such an imbalance compensation 335 may be expressed as

$${s}_{corrected} ( f ) = ( {s}_{i} ( f ) - \hat{ϕ} ( f ) {s}^{*} ( - f ) ) * \frac{1}{1 - {\hat{ϕ}}_{i} ( f ) {\hat{ϕ}}_{i}^{*} ( - f )}$$

The network entity 105-b may then transmit data transmissions to the UEs 115-c using the imbalance compensations 335 to provide increased link quality to all served UEs 115-c while reducing the processing burden on the network entity 105-b.

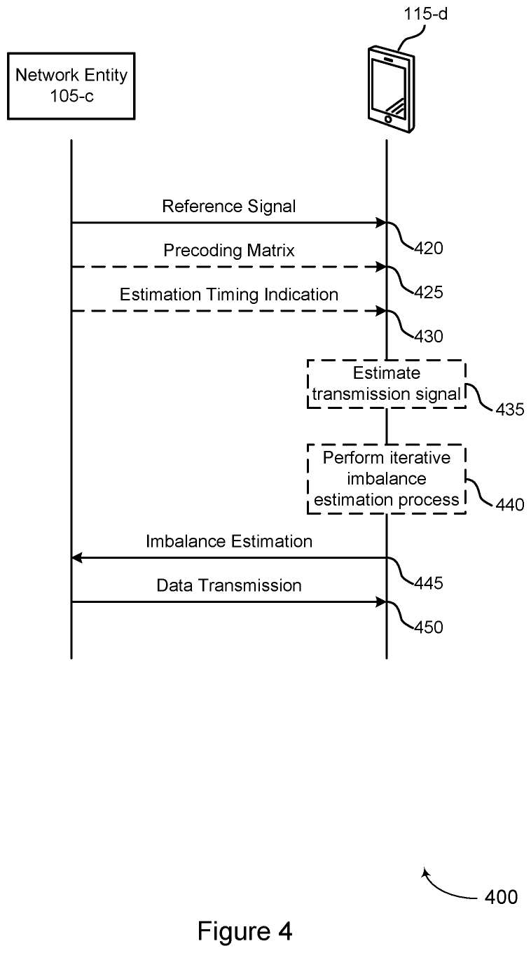

FIG. 4 illustrates an example of a process flow 400 that supports frequency domain imbalance correction in accordance with one or more examples as disclosed herein. The process flow 400 may implement various aspects of the present disclosure described herein. The elements described in the process flow 400 (for example, the UE 115-d and the network entity 105-c) may be examples of similarly-named elements described herein.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

At 420, the UE 115-d may receive, from a network entity 105-c, a reference signal.

At 425, the UE 115-d may receive, from the network entity 105-c, an indication of the precoding matrix. Additionally, or alternatively, the UE 115-d may receive, from the network entity 105-c, an indication that the UE 115-d is to estimate the frequency domain imbalance based at least in part on a default precoding matrix, in which the precoding matrix is the default precoding matrix.

At 430, the UE 115-d may receive an indication of a timing for generating the estimation of the frequency domain imbalance.

At 435, the UE 115-d may estimate a transmission signal associated with the data transmission, the transmission signal that may include the reference signal modified by the precoding matrix.

At 440, the UE 115-d may perform an iterative frequency domain imbalance estimation process that generates the estimation of the frequency domain imbalance based on satisfaction of an estimation threshold. In some examples, to perform the iterative frequency domain imbalance estimation process, the UE 115-d may estimate the channel condition; estimate, based on the channel condition and the estimated transmission signal, the frequency domain imbalance; apply a compensation parameter to the reference signal; and determine whether a difference between the estimation of the frequency domain imbalance and the frequency domain imbalance satisfies the estimation threshold. In some examples, the frequency domain imbalance is estimated by performing a least square estimation or a least minimum mean square error estimation, or any combination thereof.

At 445, the UE 115-d may transmit, to the network entity 105-c, an indication of an estimation of a frequency domain imbalance between an in-phase portion of a transmission chain of the network entity 105-c and a quadrature-phase portion of the transmission chain of the network entity 105-c, the estimation of the frequency domain imbalance being based on the reference signal, a precoding matrix associated with transmissions from the network entity 105-c, and an estimation of one or more channel conditions between the UE and the network entity 105-c. In some examples, the estimation of the frequency domain imbalance is transmitted in accordance with the timing.

At 450, the UE 115-d may receive, from the network entity 105-c, a data transmission based on transmitting the indication of the estimation of the frequency domain imbalance.

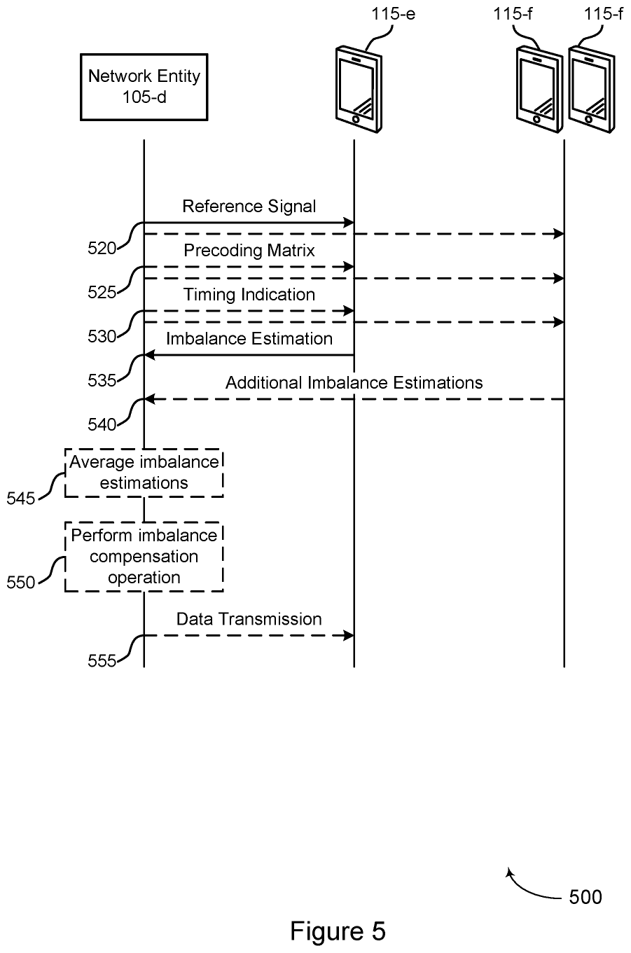

FIG. 5 illustrates an example of a process flow 500 that supports frequency domain imbalance correction in accordance with one or more examples as disclosed herein. The process flow 500 may implement various aspects of the present disclosure described herein. The elements described in the process flow 500 may be examples of similarly-named elements described herein.

In the following description of the process flow 500, the operations between the various entities or elements may be performed in different orders or at different times. Some operations may also be left out of the process flow 500, or other operations may be added. Although the various entities or elements are shown performing the operations of the process flow 500, some aspects of some operations may also be performed by other entities or elements of the process flow 500 or by entities or elements that are not depicted in the process flow, or any combination thereof.

At 520, the network entity 105-d may transmit, to a user equipment (UE) 115-e, a reference signal.

At 525, the network entity 105-d may transmit, to the UE 115-e, an indication of the precoding matrix and the precoding matrix is applied in the transmission chain of the network entity. Additionally, or alternatively, the network entity 105-d may transmit, to the UE 115-e, an indication that the UE 115-e is to estimate the frequency domain imbalance based at least in part on a default precoding matrix, in which the precoding matrix is the default precoding matrix.

At 530, the network entity 105-d may transmit an indication of a timing for generating the estimation of the frequency domain imbalance.

At 535, the network entity 105-d may receive an indication of a first estimation of a frequency domain imbalance between an in-phase portion of a transmission chain of the network entity and a quadrature-phase portion of the transmission chain of the network entity, the first estimation being based on the reference signal, a precoding matrix associated with transmissions from the network entity, and an estimation of a channel between the UE 115-e and the network entity. In some examples, the indication of the first estimation of the frequency domain imbalance is received in accordance with the timing.

At 540, the network entity 105-d may receive, from one or more other UEs, respective additional estimations of the frequency domain imbalance, each respective additional estimation being based on the reference signal, the precoding matrix, and an estimation of a channel condition between the network entity and a respective additional UE (for example, UE 115-f) of the one or more other UEs.

At 545, the network entity 105-d may the first estimation and the respective additional estimations are averaged by assigning a weight to the first estimation and each of the respective additional estimations based on a quality metric.

At 550, the network entity 105-d may perform an imbalance compensation operation associated with the transmission chain of the network entity that balances the in-phase portion and the quadrature-phase portion of the transmission chain based on the first estimation of the frequency domain imbalance. In some examples, the imbalance compensation operation may include applying the first estimation of the frequency domain imbalance to a transmission signal associated with the data transmission. In some examples, the imbalance compensation operation is performed based on an average of the first estimation and the respective additional estimations. In some examples, the imbalance compensation operation is performed after applying the precoding matrix and before modulating the in-phase portion and the quadrature-phase portion.

At 555, the network entity 105-d may transmit, to the UE 115-e, a data transmission based on performing the imbalance compensation operation.

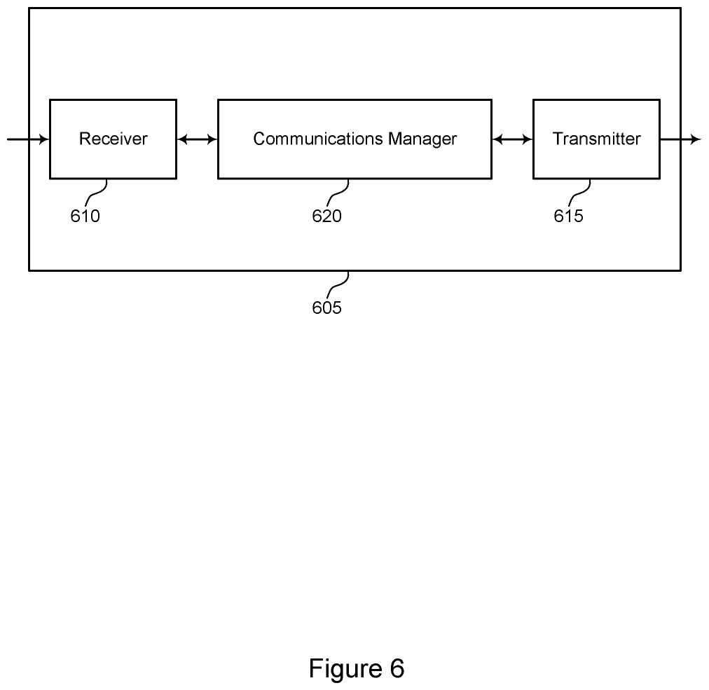

FIG. 6 illustrates a block diagram of a device 605 that supports frequency domain imbalance correction in accordance with one or more examples as disclosed herein. The device 605 may be an example of aspects of a UE 115 as described herein. The device 605 may include a receiver 610, a transmitter 615, and a communications manager 620. The communications manager 620 can be implemented, at least in part, by one or both of a modem and a processor. Each of these components may be in communication with one another (for example, via one or more buses).

The receiver 610 may provide a means for receiving information such as packets, user data, control information, or any combination thereof associated with various information channels (for example, control channels, data channels, information channels related to frequency domain imbalance correction). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (for example, control channels, data channels, information channels related to frequency domain imbalance correction). In some examples, the transmitter 615 may be co-located with a receiver 610 in a transceiver component. The transmitter 615 may utilize a single antenna or a set of multiple antennas.

The communications manager 620, the receiver 610, the transmitter 615, or various combinations thereof or various components thereof may be examples of means for performing various aspects of frequency domain imbalance correction as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (for example, in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (for example, by executing, by the processor, instructions stored in the memory).

Additionally, or alternatively, in some examples, the communications manager 620, the receiver 610, the transmitter 615, or various combinations or components thereof may be implemented in code (for example, as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (for example, configured as or otherwise supporting a means for performing the functions described in the present disclosure).

In some examples, the communications manager 620 may be configured to perform various operations (for example, receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

Additionally, or alternatively, the communications manager 620 may support wireless communication at a UE in accordance with examples as disclosed herein. For example, the communications manager 620 may be configured as or otherwise support a means for receiving, from a network entity, a reference signal. The communications manager 620 may be configured as or otherwise support a means for transmitting, to the network entity, an indication of an estimation of a frequency domain imbalance between an in-phase portion of the reference signal and a quadrature-phase portion of the reference signal based on a precoding matrix associated with transmissions from the network entity, and an estimation of one or more channel conditions between the UE and the network entity. The communications manager 620 may be configured as or otherwise support a means for receiving, from the network entity, a data transmission based on transmitting the indication of the estimation of the frequency domain imbalance.

By including or configuring the communications manager 620 in accordance with examples as described herein, the device 605 (for example, a processor controlling or otherwise coupled with the receiver 610, the transmitter 615, the communications manager 620, or a combination thereof) may support techniques for reduced processing, reduced power consumption, more efficient utilization of communication resources, or any combination thereof.

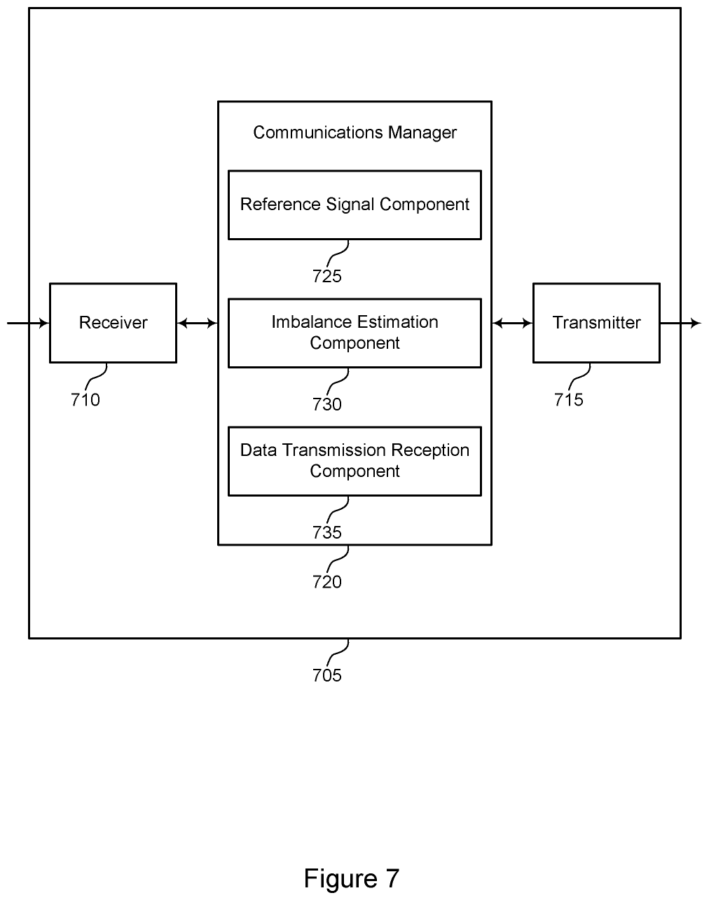

FIG. 7 illustrates a block diagram of a device 705 that supports frequency domain imbalance correction in accordance with one or more examples as disclosed herein. The device 705 may be an example of aspects of a device 605 or a UE 115 as described herein. The device 705 may include a receiver 710, a transmitter 715, and a communications manager 720. The communications manager 720 can be implemented, at least in part, by one or both of a modem and a processor. Each of these components may be in communication with one another (for example, via one or more buses).

The receiver 710 may provide a means for receiving information such as packets, user data, control information, or any combination thereof associated with various information channels (for example, control channels, data channels, information channels related to frequency domain imbalance correction). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (for example, control channels, data channels, information channels related to frequency domain imbalance correction). In some examples, the transmitter 715 may be co-located with a receiver 710 in a transceiver component. The transmitter 715 may utilize a single antenna or a set of multiple antennas.

The device 705, or various components thereof, may be an example of means for performing various aspects of frequency domain imbalance correction as described herein. For example, the communications manager 720 may include a reference signal component 725, an imbalance estimation component 730, a data transmission reception component 735, or any combination thereof. In some examples, the communications manager 720, or various components thereof, may be configured to perform various operations (for example, receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The reference signal component 725 may be configured as or otherwise support a means for receiving, from a network entity, a reference signal. The imbalance estimation component 730 may be configured as or otherwise support a means for transmitting, to the network entity, an indication of an estimation of a frequency domain imbalance between an in-phase portion of the reference signal and a quadrature-phase portion of the reference signal based on a precoding matrix associated with transmissions from the network entity, and an estimation of one or more channel conditions between the UE and the network entity. The data transmission reception component 735 may be configured as or otherwise support a means for receiving, from the network entity, a data transmission based on transmitting the indication of the estimation of the frequency domain imbalance.

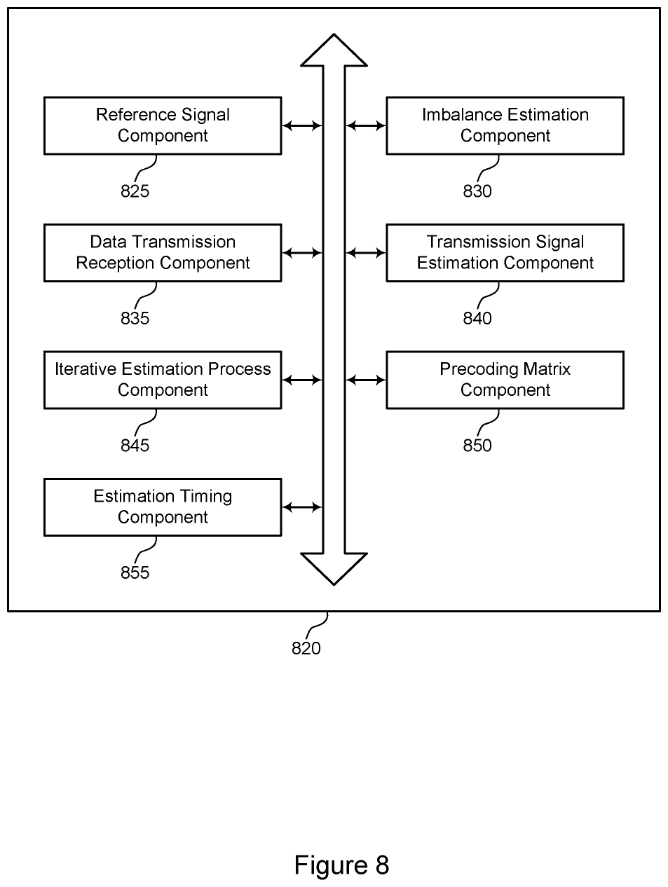

FIG. 8 illustrates a block diagram of a communications manager 820 that supports frequency domain imbalance correction in accordance with one or more examples as disclosed herein. The communications manager 820, or various components thereof, may be an example of means for performing various aspects of frequency domain imbalance correction as described herein. For example, the communications manager 820 may include a reference signal component 825, an imbalance estimation component 830, a data transmission reception component 835, a transmission signal estimation component 840, an iterative estimation process component 845, a precoding matrix component 850, an estimation timing component 855, or any combination thereof. Each of these components may communicate, directly or indirectly, with one another (for example, via one or more buses).

Additionally, or alternatively, the communications manager 820 may support wireless communication at a UE in accordance with examples as disclosed herein. The reference signal component 825 may be configured as or otherwise support a means for receiving, from a network entity, a reference signal. The imbalance estimation component 830 may be configured as or otherwise support a means for transmitting, to the network entity, an indication of an estimation of a frequency domain imbalance between an in-phase portion of the reference signal and a quadrature-phase portion of the reference signal based on a precoding matrix associated with transmissions from the network entity, and an estimation of one or more channel conditions between the UE and the network entity. The data transmission reception component 835 may be configured as or otherwise support a means for receiving, from the network entity, a data transmission based on transmitting the indication of the estimation of the frequency domain imbalance.

In some examples, the reference signal is affected by the channel condition and the frequency domain imbalance, and the transmission signal estimation component 840 may be configured as or otherwise support a means for estimating a transmission signal associated with the data transmission, the transmission signal including the reference signal modified by the precoding matrix. In some examples, the reference signal is affected by the channel condition and the frequency domain imbalance, and the iterative estimation process component 845 may be configured as or otherwise support a means for performing an iterative frequency domain imbalance estimation process that generates the estimation of the frequency domain imbalance based on satisfaction of an estimation threshold.

In some examples, to support iterative frequency domain imbalance estimation process, the iterative estimation process component 845 may be configured as or otherwise support a means for estimating the channel condition. In some examples, to support iterative frequency domain imbalance estimation process, the iterative estimation process component 845 may be configured as or otherwise support a means for estimating, based on the channel condition and the transmission signal, the frequency domain imbalance. In some examples, to support iterative frequency domain imbalance estimation process, the iterative estimation process component 845 may be configured as or otherwise support a means for applying a compensation parameter to the reference signal. In some examples, to support iterative frequency domain imbalance estimation process, the iterative estimation process component 845 may be configured as or otherwise support a means for determining whether a difference between the estimation of the frequency domain imbalance and the frequency domain imbalance satisfies the estimation threshold.

In some examples, the frequency domain imbalance is estimated by performing a least square estimation or a least minimum mean square error estimation, or any combination thereof.

In some examples, the precoding matrix component 850 may be configured as or otherwise support a means for receiving, from the network entity, an indication of the precoding matrix. In some examples, the precoding matrix component 850 may be configured as or otherwise support a means for receiving, from the network entity, an indication that the UE is to estimate the frequency domain imbalance based at least in part on a default precoding matrix, in which the precoding matrix is the default precoding matrix.

In some examples, the estimation timing component 855 may be configured as or otherwise support a means for receiving an indication of a timing for generating the estimation of the frequency domain imbalance. In some examples, the estimation timing component 855 may be configured as or otherwise support a means for where the estimation of the frequency domain imbalance is transmitted in accordance with the timing.

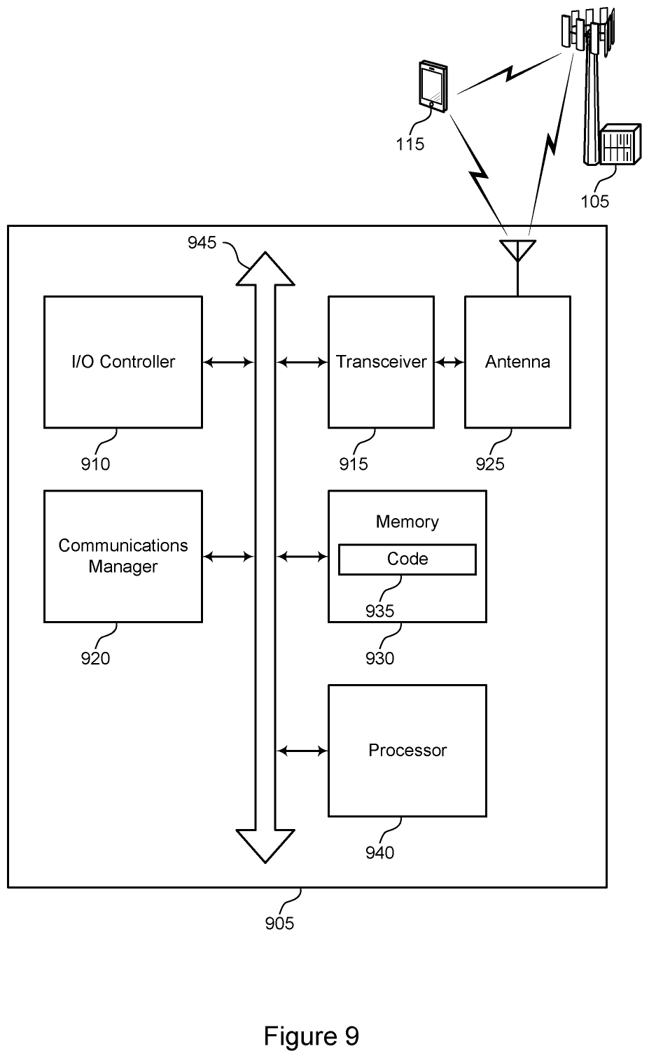

FIG. 9 illustrates a diagram of a system including a device 905 that supports frequency domain imbalance correction in accordance with one or more examples as disclosed herein. The device 905 may be an example of or include the components of a device 605, a device 705, or a UE 115 as described herein. The device 905 may communicate (for example, wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (for example, operatively, communicatively, functionally, electronically, electrically) via one or more buses (for example, a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (for example, when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (for example, a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (for example, the memory 930) to cause the device 905 to perform various functions (for example, functions or tasks supporting frequency domain imbalance correction). For example, the device 905 or a component of the device 905 may include a processor 940 and memory 930 coupled with or to the processor 940, the processor 940 and memory 930 configured to perform various functions described herein.

Additionally, or alternatively, the communications manager 920 may support wireless communication at a UE in accordance with examples as disclosed herein. For example, the communications manager 920 may be configured as or otherwise support a means for receiving, from a network entity, a reference signal. The communications manager 920 may be configured as or otherwise support a means for transmitting, to the network entity, an indication of an estimation of a frequency domain imbalance between an in-phase portion of the reference signal and a quadrature-phase portion of the reference signal based on a precoding matrix associated with transmissions from the network entity, and an estimation of one or more channel conditions between the UE and the network entity. The communications manager 920 may be configured as or otherwise support a means for receiving, from the network entity, a data transmission based on transmitting the indication of the estimation of the frequency domain imbalance.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 920 may be configured to perform various operations (for example, receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of frequency domain imbalance correction as described herein, or the processor 940 and the memory 930 may be otherwise configured to perform or support such operations.

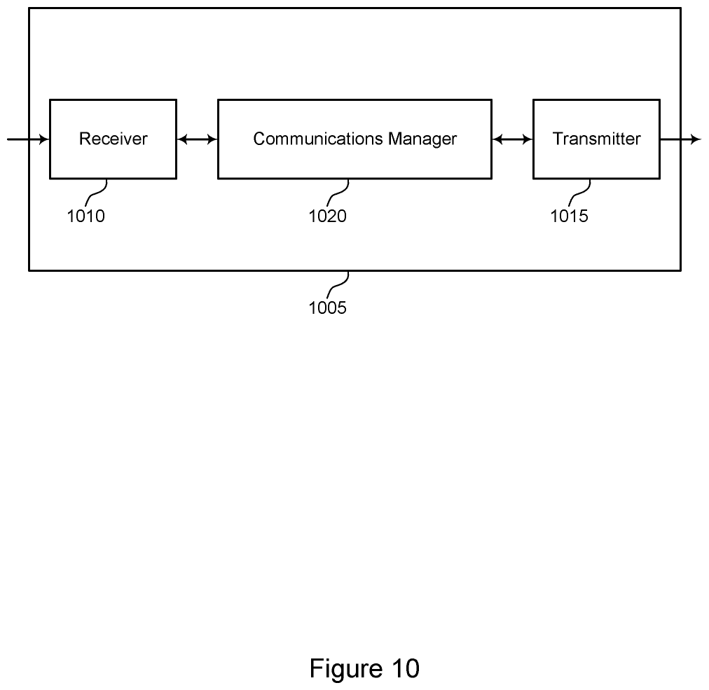

FIG. 10 illustrates a block diagram of a device 1005 that supports frequency domain imbalance correction in accordance with one or more examples as disclosed herein. The device 1005 may be an example of aspects of a network entity 105 as described herein. The device 1005 may include a receiver 1010, a transmitter 1015, and a communications manager 1020. The communications manager 1020 can be implemented, at least in part, by one or both of a modem and a processor. Each of these components may be in communication with one another (for example, via one or more buses).

The receiver 1010 may provide a means for obtaining (for example, receiving, determining, identifying) information such as user data, control information, or any combination thereof (for example, I/Q samples, symbols, packets, protocol data units, service data units) associated with various channels (for example, control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (for example, electrical, fiber optic) interfaces, wireless interfaces, or any combination thereof.

The transmitter 1015 may provide a means for outputting (for example, transmitting, providing, conveying, sending) information generated by other components of the device 1005. For example, the transmitter 1015 may output information such as user data, control information, or any combination thereof (for example, I/Q samples, symbols, packets, protocol data units, service data units) associated with various channels (for example, control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (for example, electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of frequency domain imbalance correction as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (for example, in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (for example, by executing, by the processor, instructions stored in the memory).

Additionally, or alternatively, in some examples, the communications manager 1020, the receiver 1010, the transmitter 1015, or various combinations or components thereof may be implemented in code (for example, as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (for example, configured as or otherwise supporting a means for performing the functions described in the present disclosure).

In some examples, the communications manager 1020 may be configured to perform various operations (for example, receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

Additionally, or alternatively, the communications manager 1020 may support wireless communication at a network entity in accordance with examples as disclosed herein. For example, the communications manager 1020 may be configured as or otherwise support a means for transmitting, to a UE, a reference signal. The communications manager 1020 may be configured as or otherwise support a means for receiving an indication of a first estimation of a frequency domain imbalance between an in-phase portion of a transmission chain of the network entity and a quadrature-phase portion of the transmission chain of the network entity, the first estimation being based on the reference signal, a precoding matrix associated with transmissions from the network entity, and an estimation of a channel between the UE and the network entity. The communications manager 1020 may be configured as or otherwise support a means for performing an imbalance compensation operation associated with the transmission chain of the network entity that balances the in-phase portion and the quadrature-phase portion of the transmission chain based on the first estimation of the frequency domain imbalance. The communications manager 1020 may be configured as or otherwise support a means for transmitting, to the UE, a data transmission based on performing the imbalance compensation operation.

By including or configuring the communications manager 1020 in accordance with examples as described herein, the device 1005 (for example, a processor controlling or otherwise coupled with the receiver 1010, the transmitter 1015, the communications manager 1020, or a combination thereof) may support techniques for reduced processing, reduced power consumption, more efficient utilization of communication resources, or any combination thereof.

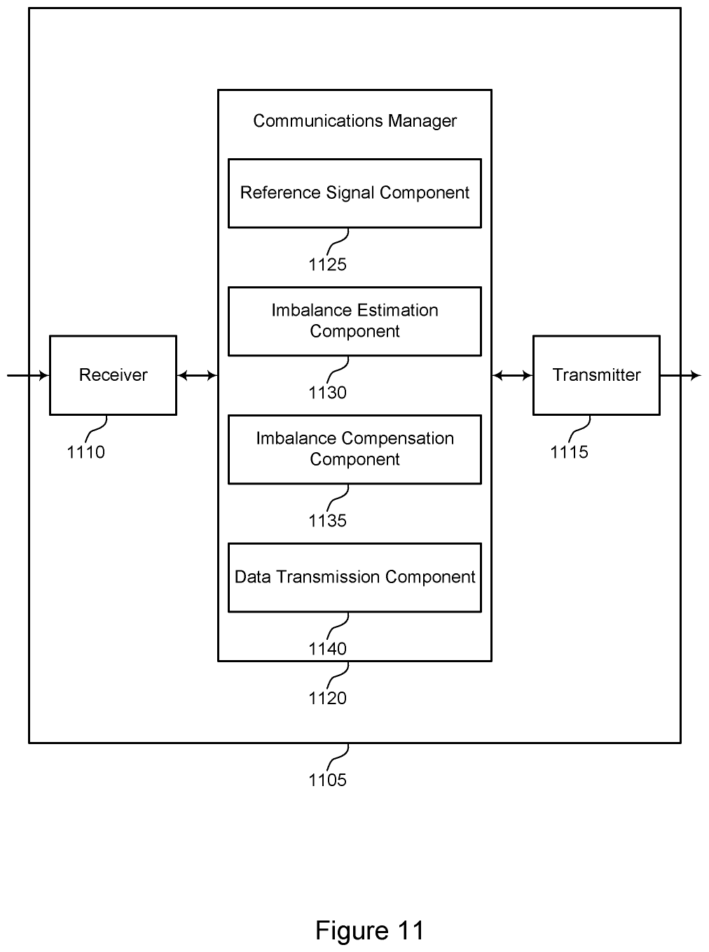

FIG. 11 illustrates a block diagram of a device 1105 that supports frequency domain imbalance correction in accordance with one or more examples as disclosed herein. The device 1105 may be an example of aspects of a device 1005 or a network entity 105 as described herein. The device 1105 may include a receiver 1110, a transmitter 1115, and a communications manager 1120. The communications manager 1120 can be implemented, at least in part, by one or both of a modem and a processor. Each of these components may be in communication with one another (for example, via one or more buses).

The receiver 1110 may provide a means for obtaining (for example, receiving, determining, identifying) information such as user data, control information, or any combination thereof (for example, I/Q samples, symbols, packets, protocol data units, service data units) associated with various channels (for example, control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (for example, electrical, fiber optic) interfaces, wireless interfaces, or any combination thereof.

The transmitter 1115 may provide a means for outputting (for example, transmitting, providing, conveying, sending) information generated by other components of the device 1105. For example, the transmitter 1115 may output information such as user data, control information, or any combination thereof (for example, I/Q samples, symbols, packets, protocol data units, service data units) associated with various channels (for example, control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (for example, electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of frequency domain imbalance correction as described herein. For example, the communications manager 1120 may include a reference signal component 1125, an imbalance estimation component 1130, an imbalance compensation component 1135, a data transmission component 1140, or any combination thereof. In some examples, the communications manager 1120, or various components thereof, may be configured to perform various operations (for example, receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The reference signal component 1125 may be configured as or otherwise support a means for transmitting, to a UE, a reference signal. The imbalance estimation component 1130 may be configured as or otherwise support a means for receiving an indication of a first estimation of a frequency domain imbalance between an in-phase portion of a transmission chain of the network entity and a quadrature-phase portion of the transmission chain of the network entity, the first estimation being based on the reference signal, a precoding matrix associated with transmissions from the network entity, and an estimation of a channel between the UE and the network entity. The imbalance compensation component 1135 may be configured as or otherwise support a means for performing an imbalance compensation operation associated with the transmission chain of the network entity that balances the in-phase portion and the quadrature-phase portion of the transmission chain based on the first estimation of the frequency domain imbalance. The data transmission component 1140 may be configured as or otherwise support a means for transmitting, to the UE, a data transmission based on performing the imbalance compensation operation.

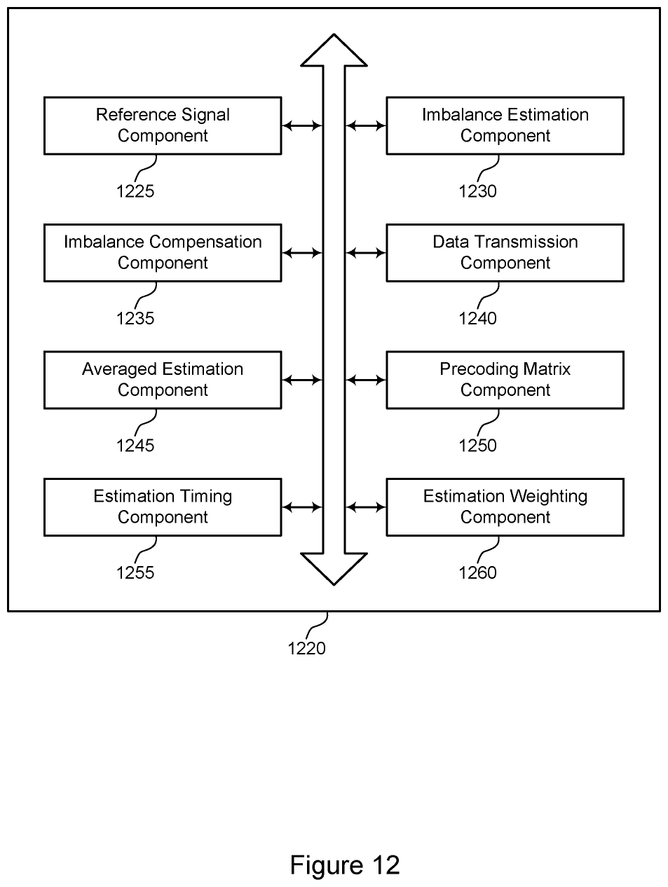

FIG. 12 illustrates a block diagram of a communications manager 1220 that supports frequency domain imbalance correction in accordance with one or more examples as disclosed herein. The communications manager 1220, or various components thereof, may be an example of means for performing various aspects of frequency domain imbalance correction as described herein. For example, the communications manager 1220 may include a reference signal component 1225, an imbalance estimation component 1230, an imbalance compensation component 1235, a data transmission component 1240, an averaged estimation component 1245, a precoding matrix component 1250, an estimation timing component 1255, an estimation weighting component 1260, or any combination thereof. Each of these components may communicate, directly or indirectly, with one another (for example, via one or more buses) which may include communications within a protocol layer of a protocol stack, communications associated with a logical channel of a protocol stack (for example, between protocol layers of a protocol stack, within a device, component, or virtualized component associated with a network entity 105, between devices, components, or virtualized components associated with a network entity 105), or any combination thereof.

Additionally, or alternatively, the communications manager 1220 may support wireless communication at a network entity in accordance with examples as disclosed herein. The reference signal component 1225 may be configured as or otherwise support a means for transmitting, to a UE, a reference signal. The imbalance estimation component 1230 may be configured as or otherwise support a means for receiving an indication of a first estimation of a frequency domain imbalance between an in-phase portion of a transmission chain of the network entity and a quadrature-phase portion of the transmission chain of the network entity, the first estimation being based on the reference signal, a precoding matrix associated with transmissions from the network entity, and an estimation of a channel between the UE and the network entity. The imbalance compensation component 1235 may be configured as or otherwise support a means for performing an imbalance compensation operation associated with the transmission chain of the network entity that balances the in-phase portion and the quadrature-phase portion of the transmission chain based on the first estimation of the frequency domain imbalance. The data transmission component 1240 may be configured as or otherwise support a means for transmitting, to the UE, a data transmission based on performing the imbalance compensation operation.

In some examples, the imbalance compensation operation includes applying the first estimation of the frequency domain imbalance to a transmission signal associated with the data transmission.

In some examples, the averaged estimation component 1245 may be configured as or otherwise support a means for receiving, from one or more other UEs, respective additional estimations of the frequency domain imbalance, each respective additional estimation being based on the reference signal, the precoding matrix, and an estimation of a channel condition between the network entity and a respective additional UE of the one or more other UEs. In some examples, the averaged estimation component 1245 may be configured as or otherwise support a means for where the imbalance compensation operation is performed based on an average of the first estimation and the respective additional estimations.

In some examples, the first estimation and the respective additional estimations are averaged by assigning a weight to the first estimation and each of the respective additional estimations based on a quality metric.

In some examples, the precoding matrix component 1250 may be configured as or otherwise support a means for transmitting, to the UE, an indication of the precoding matrix, where the precoding matrix is applied in the transmission chain of the network entity. In some examples, the precoding matrix component 1250 may be configured as or otherwise support a means for transmitting, to the UE, an indication that the UE is to estimate the frequency domain imbalance based at least in part on a default precoding matrix, where the precoding matrix is the default precoding matrix.

In some examples, the imbalance compensation operation is performed after applying the precoding matrix and before modulating the in-phase portion and the quadrature-phase portion.

In some examples, the estimation timing component 1255 may be configured as or otherwise support a means for transmitting an indication of a timing for generating the estimation of the frequency domain imbalance. In some examples, the estimation timing component 1255 may be configured as or otherwise support a means for where the indication of the first estimation of the frequency domain imbalance is received in accordance with the timing.

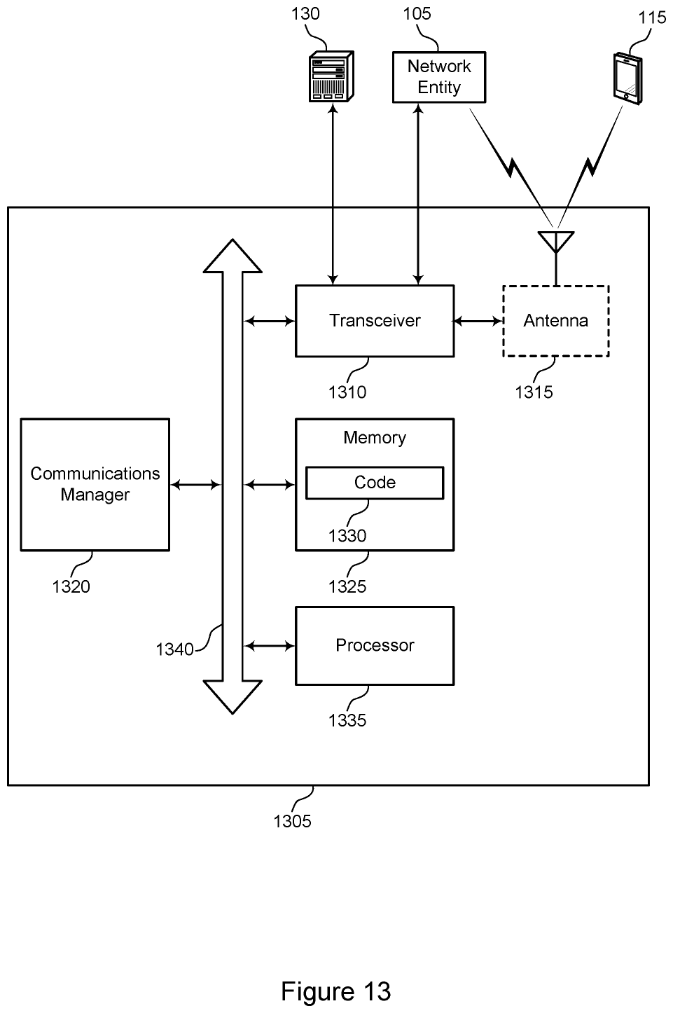

FIG. 13 illustrates a diagram of a system including a device 1305 that supports frequency domain imbalance correction in accordance with one or more examples as disclosed herein. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (for example, operatively, communicatively, functionally, electronically, electrically) via one or more buses (for example, a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (for example, concurrently). The transceiver 1310 may also include a modem to modulate signals, to provide the modulated signals for transmission (for example, by one or more antennas 1315, by a wired transmitter), to receive modulated signals (for example, from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (for example, a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (for example, when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (for example, a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (for example, the memory 1325) to cause the device 1305 to perform various functions (for example, functions or tasks supporting frequency domain imbalance correction). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (for example, one or more physical nodes and supporting software such as operating systems, virtual machines, or container instances) that may host the functions (for example, by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (for example, within) a protocol layer of a protocol stack. In some examples, a bus 1340 may support communications associated with a logical channel of a protocol stack (for example, between protocol layers of a protocol stack), which may include communications performed within a component of the device 1305, or between different components of the device 1305 that may be co-located or located in different locations (for example, where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (for example, via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

Additionally, or alternatively, the communications manager 1320 may support wireless communication at a network entity in accordance with examples as disclosed herein. For example, the communications manager 1320 may be configured as or otherwise support a means for transmitting, to a UE, a reference signal. The communications manager 1320 may be configured as or otherwise support a means for receiving an indication of a first estimation of a frequency domain imbalance between an in-phase portion of a transmission chain of the network entity and a quadrature-phase portion of the transmission chain of the network entity, the first estimation being based on the reference signal, a precoding matrix associated with transmissions from the network entity, and an estimation of a channel between the UE and the network entity. The communications manager 1320 may be configured as or otherwise support a means for performing an imbalance compensation operation associated with the transmission chain of the network entity that balances the in-phase portion and the quadrature-phase portion of the transmission chain based on the first estimation of the frequency domain imbalance. The communications manager 1320 may be configured as or otherwise support a means for transmitting, to the UE, a data transmission based on performing the imbalance compensation operation.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1320 may be configured to perform various operations (for example, receiving, obtaining, monitoring, outputting, transmitting) using or otherwise in cooperation with the transceiver 1310, the one or more antennas 1315 (for example, where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of frequency domain imbalance correction as described herein, or the processor 1335 and the memory 1325 may be otherwise configured to perform or support such operations.

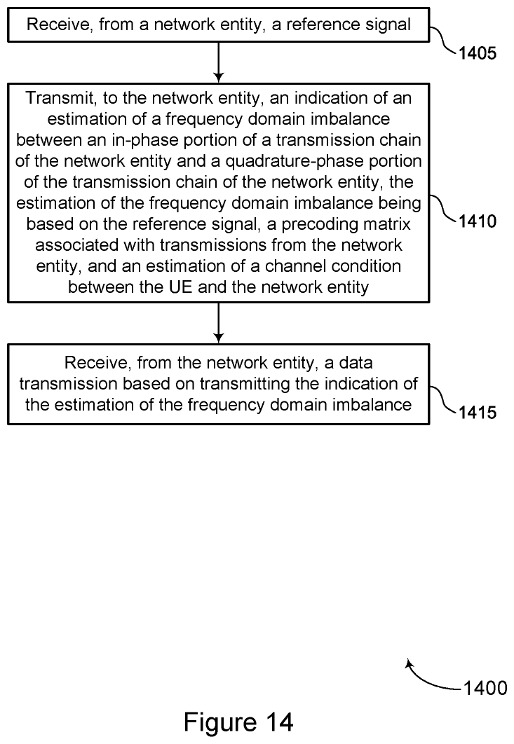

FIG. 14 illustrates a flowchart illustrating a method 1400 that supports frequency domain imbalance correction in accordance with one or more examples as disclosed herein. The operations of the method 1400 may be implemented by a UE or its components as described herein. For example, the operations of the method 1400 may be performed by a UE 115 as described with reference to FIGS. 1-9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, a reference signal. The operations of 1405 may be performed in accordance with examples as disclosed herein. In some examples, aspects of the operations of 1405 may be performed by a reference signal component 825 as described with reference to FIG. 8.

At 1410, the method may include transmitting, to the network entity, an indication of an estimation of a frequency domain imbalance between an in-phase portion of the reference signal and a quadrature-phase portion of the reference signal based on a precoding matrix associated with transmissions from the network entity, and an estimation of one or more channel conditions between the UE and the network entity. The operations of 1410 may be performed in accordance with examples as disclosed herein. In some examples, aspects of the operations of 1410 may be performed by an imbalance estimation component 830 as described with reference to FIG. 8.

At 1415, the method may include receiving, from the network entity, a data transmission based on transmitting the indication of the estimation of the frequency domain imbalance. The operations of 1415 may be performed in accordance with examples as disclosed herein. In some examples, aspects of the operations of 1415 may be performed by a data transmission reception component 835 as described with reference to FIG. 8.

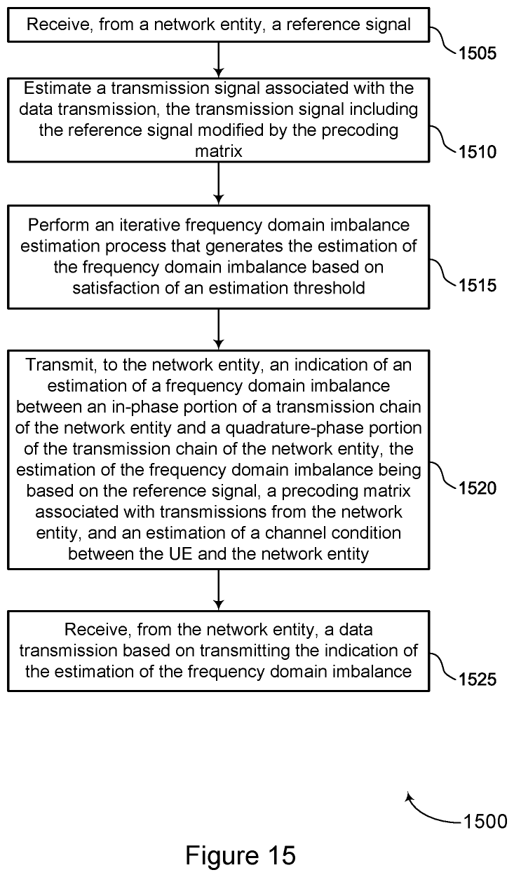

FIG. 15 illustrates a flowchart illustrating a method 1500 that supports frequency domain imbalance correction in accordance with one or more examples as disclosed herein. The operations of the method 1500 may be implemented by a UE or its components as described herein. For example, the operations of the method 1500 may be performed by a UE 115 as described with reference to FIGS. 1-9. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, a reference signal. The operations of 1505 may be performed in accordance with examples as disclosed herein. In some examples, aspects of the operations of 1505 may be performed by a reference signal component 825 as described with reference to FIG. 8.

At 1510, the method may include estimating a transmission signal associated with the data transmission, the transmission signal including the reference signal modified by the precoding matrix. The operations of 1510 may be performed in accordance with examples as disclosed herein. In some examples, aspects of the operations of 1510 may be performed by a transmission signal estimation component 840 as described with reference to FIG. 8.

At 1515, the method may include performing an iterative frequency domain imbalance estimation process that generates the estimation of the frequency domain imbalance based on satisfaction of an estimation threshold. The operations of 1515 may be performed in accordance with examples as disclosed herein. In some examples, aspects of the operations of 1515 may be performed by an iterative estimation process component 845 as described with reference to FIG. 8.

At 1520, the method may include transmitting, to the network entity, an indication of an estimation of a frequency domain imbalance between an in-phase portion of the reference signal and a quadrature-phase portion of the reference signal based on a precoding matrix associated with transmissions from the network entity, and an estimation of one or more channel conditions between the UE and the network entity. The operations of 1520 may be performed in accordance with examples as disclosed herein. In some examples, aspects of the operations of 1520 may be performed by an imbalance estimation component 830 as described with reference to FIG. 8.

At 1525, the method may include receiving, from the network entity, a data transmission based on transmitting the indication of the estimation of the frequency domain imbalance. The operations of 1525 may be performed in accordance with examples as disclosed herein. In some examples, aspects of the operations of 1525 may be performed by a data transmission reception component 835 as described with reference to FIG. 8.

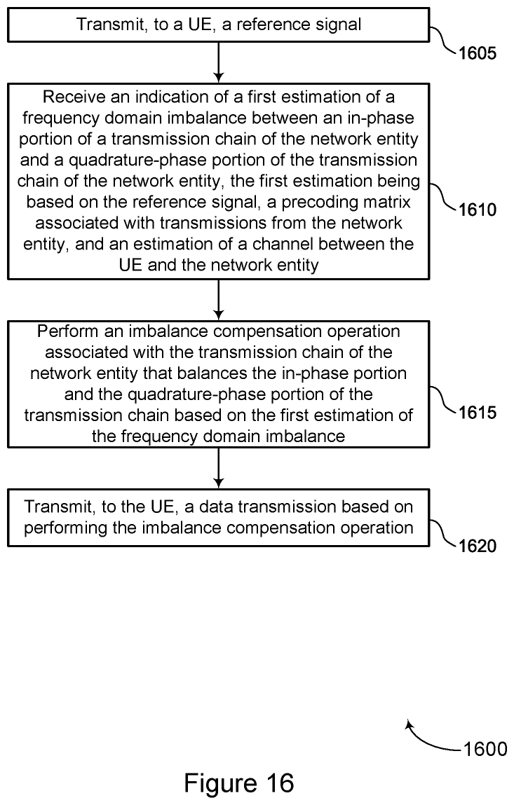

FIG. 16 illustrates a flowchart illustrating a method 1600 that supports frequency domain imbalance correction in accordance with one or more examples as disclosed herein. The operations of the method 1600 may be implemented by a network entity or its components as described herein. For example, the operations of the method 1600 may be performed by a network entity as described with reference to FIGS. 1-5 and 10-13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, a reference signal. The operations of 1605 may be performed in accordance with examples as disclosed herein. In some examples, aspects of the operations of 1605 may be performed by a reference signal component 1225 as described with reference to FIG. 12.

At 1610, the method may include receiving an indication of a first estimation of a frequency domain imbalance between an in-phase portion of a transmission chain of the network entity and a quadrature-phase portion of the transmission chain of the network entity, the first estimation being based on the reference signal, a precoding matrix associated with transmissions from the network entity, and an estimation of a channel between the UE and the network entity. The operations of 1610 may be performed in accordance with examples as disclosed herein. In some examples, aspects of the operations of 1610 may be performed by an imbalance estimation component 1230 as described with reference to FIG. 12.

At 1615, the method may include performing an imbalance compensation operation associated with the transmission chain of the network entity that balances the in-phase portion and the quadrature-phase portion of the transmission chain based on the first estimation of the frequency domain imbalance. The operations of 1615 may be performed in accordance with examples as disclosed herein. In some examples, aspects of the operations of 1615 may be performed by an imbalance compensation component 1235 as described with reference to FIG. 12.

At 1620, the method may include transmitting, to the UE, a data transmission based on performing the imbalance compensation operation. The operations of 1620 may be performed in accordance with examples as disclosed herein. In some examples, aspects of the operations of 1620 may be performed by a data transmission component 1240 as described with reference to FIG. 12.

The following provides an overview of aspects of the present disclosure:

Aspect 1: A method for wireless communication at a UE, comprising: receiving, from a network entity, a reference signal; transmitting, to the network entity, an indication of an estimation of a frequency domain imbalance between an in-phase portion of the reference signal and a quadrature-phase portion of the reference signal based at least in part on a precoding matrix associated with transmissions from the network entity and an estimation of one or more channel conditions between the UE and the network entity; and receiving, from the network entity, a data transmission based at least in part on transmitting the indication of the estimation of the frequency domain imbalance.

Aspect 2: The method of aspect 1, wherein the reference signal is affected by the channel condition and the frequency domain imbalance, the method further comprising: estimating a transmission signal associated with the data transmission, the transmission signal comprising the reference signal modified by the precoding matrix; and performing an iterative frequency domain imbalance estimation process that generates the estimation of the frequency domain imbalance based at least in part on satisfaction of an estimation threshold.

Aspect 3: The method of aspect 2, wherein the iterative frequency domain imbalance estimation process comprises: estimating the channel condition; estimating, based at least in part on the channel condition and the transmission signal, the frequency domain imbalance; applying a compensation parameter to the reference signal; and determining whether a difference between the estimation of the frequency domain imbalance and the frequency domain imbalance satisfies the estimation threshold.

Aspect 4: The method of any of aspects 2 through 3, wherein the frequency domain imbalance is estimated by performing a least square estimation or a least minimum mean square error estimation, or any combination thereof.

Aspect 5: The method of any of aspects 1 through 4, further comprising receiving, from the network entity, an indication of the precoding matrix.

Aspect 6: The method of any of aspects 1 through 5, further comprising: receiving, from the network entity, an indication that the UE is to estimate the frequency domain imbalance based at least in part on a default precoding matrix, wherein the precoding matrix is the default precoding matrix.

Aspect 7: The method of any of aspects 1 through 6, further comprising: receiving an indication of a timing for generating the estimation of the frequency domain imbalance, wherein the estimation of the frequency domain imbalance is transmitted in accordance with the timing.

Aspect 8: A method for wireless communication at a network entity, comprising: transmitting, to a UE, a reference signal; receiving an indication of a first estimation of a frequency domain imbalance between an in-phase portion of a transmission chain of the network entity and a quadrature-phase portion of the transmission chain of the network entity, the first estimation being based at least in part on the reference signal, a precoding matrix associated with transmissions from the network entity, and an estimation of a channel between the UE and the network entity; performing an imbalance compensation operation associated with the transmission chain of the network entity that balances the in-phase portion and the quadrature-phase portion of the transmission chain based at least in part on the first estimation of the frequency domain imbalance; and transmitting, to the UE, a data transmission based at least in part on performing the imbalance compensation operation.

Aspect 9: The method of aspect 8, wherein the imbalance compensation operation comprises applying the first estimation of the frequency domain imbalance to a transmission signal associated with the data transmission.

Aspect 10: The method of any of aspects 8 through 9, further comprising: receiving, from one or more other UEs, respective additional estimations of the frequency domain imbalance, each respective additional estimation being based at least in part on the reference signal, the precoding matrix, and an estimation of a channel condition between the network entity and a respective additional UE of the one or more other UEs, wherein the imbalance compensation operation is performed based at least in part on an average of the first estimation and the respective additional estimations.

Aspect 11: The method of aspect 10, wherein the first estimation and the respective additional estimations are averaged by assigning a weight to the first estimation and each of the respective additional estimations based at least in part on a quality metric.

Aspect 12: The method of any of aspects 8 through 11, further comprising transmitting, to the UE, an indication of the precoding matrix, wherein the precoding matrix is applied in the transmission chain of the network entity.

Aspect 13: The method of any of aspects 8 through 12, further comprising: transmitting, to the UE, an indication that the UE is to estimate the frequency domain imbalance based at least in part on a default precoding matrix, wherein the precoding matrix is the default precoding matrix.

Aspect 14: The method of any of aspects 8 through 13, wherein the imbalance compensation operation is performed after applying the precoding matrix and before modulating the in-phase portion and the quadrature-phase portion.

Aspect 15: The method of any of aspects 8 through 14, further comprising: transmitting an indication of a timing for generating the estimation of the frequency domain imbalance, wherein the indication of the first estimation of the frequency domain imbalance is received in accordance with the timing.

Aspect 16: An apparatus for wireless communication at a UE, comprising a processor; memory coupled with the processor; and instructions stored in the memory and executable by the processor to cause the apparatus to perform a method of any of aspects 1 through 7.

Aspect 17: An apparatus for wireless communication at a UE, comprising at least one means for performing a method of any of aspects 1 through 7.

Aspect 18: A non-transitory computer-readable medium storing code for wireless communication at a UE, the code comprising instructions executable by a processor to perform a method of any of aspects 1 through 7.

Aspect 19: An apparatus for wireless communication at a network entity, comprising a processor; memory coupled with the processor; and instructions stored in the memory and executable by the processor to cause the apparatus to perform a method of any of aspects 8 through 15.

Aspect 20: An apparatus for wireless communication at a network entity, comprising at least one means for performing a method of any of aspects 8 through 15.

Aspect 21: A non-transitory computer-readable medium storing code for wireless communication at a network entity, the code comprising instructions executable by a processor to perform a method of any of aspects 8 through 15.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (for example, A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (for example, receiving information), accessing (for example, accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor; and
memory coupled with the processor and storing instructions executable by the processor to cause the apparatus to:
receive, from a network entity, a reference signal;
transmit, to the network entity, an indication of an estimation of a frequency domain imbalance between an in-phase portion of the reference signal and a quadrature-phase portion of the reference signal based at least in part on a precoding matrix associated with transmissions from the network entity and an estimation of one or more channel conditions between the UE and the network entity; and
receive, from the network entity, a data transmission based at least in part on transmitting the indication of the estimation of the frequency domain imbalance.

2. The apparatus of claim 1, wherein the reference signal is affected by the one or more channel conditions and the frequency domain imbalance, and the instructions are further executable by the processor to cause the apparatus to:
estimate a transmission signal associated with the data transmission, the transmission signal comprising the reference signal modified by the precoding matrix; and
perform an iterative frequency domain imbalance estimation process that generates the estimation of the frequency domain imbalance based at least in part on satisfaction of an estimation threshold.

3. The apparatus of claim 2, wherein the instructions to perform the iterative frequency domain imbalance estimation process are executable by the processor to cause the apparatus to:
estimate the one or more channel conditions;
estimate, based at least in part on the one or more channel conditions and the estimated transmission signal, the frequency domain imbalance;
apply a compensation parameter to the reference signal; and
determine whether a difference between the estimation of the frequency domain imbalance and the frequency domain imbalance satisfies the estimation threshold.

4. The apparatus of claim 2, wherein the frequency domain imbalance is estimated by performing a least square estimation or a least minimum mean square error estimation, or any combination thereof.

5. The apparatus of claim 1, wherein the instructions are further executable by the processor to cause the apparatus to receive, from the network entity, an indication of the precoding matrix.

6. The apparatus of claim 1, wherein the instructions are further executable by the processor to cause the apparatus to:
receive, from the network entity, an indication that the UE is to estimate the frequency domain imbalance based at least in part on a default precoding matrix,
wherein the precoding matrix is the default precoding matrix.

7. The apparatus of claim 1, wherein the instructions are further executable by the processor to cause the apparatus to:
receive an indication of a timing for generating the estimation of the frequency domain imbalance,
wherein the estimation of the frequency domain imbalance is transmitted in accordance with the timing.

8. An apparatus for wireless communication at a network entity, comprising:
a processor; and
memory coupled with the processor and storing instructions executable by the processor to cause the apparatus to:
transmit, to a user equipment (UE), a reference signal;
receive an indication of a first estimation of a frequency domain imbalance between an in-phase portion of a transmission chain of the network entity and a quadrature-phase portion of the transmission chain of the network entity, the first estimation being based at least in part on the reference signal, a precoding matrix associated with transmissions from the network entity, and an estimation of a channel between the UE and the network entity;
perform an imbalance compensation operation associated with the transmission chain of the network entity that balances the in-phase portion and the quadrature-phase portion of the transmission chain based at least in part on the first estimation of the frequency domain imbalance; and
transmit, to the UE, a data transmission based at least in part on performing the imbalance compensation operation.

9. The apparatus of claim 8, wherein the imbalance compensation operation comprises applying the first estimation of the frequency domain imbalance to a transmission signal associated with the data transmission.

10. The apparatus of claim 8, wherein the instructions are further executable by the processor to cause the apparatus to:
receive, from one or more other UEs, respective additional estimations of the frequency domain imbalance, each respective additional estimation being based at least in part on the reference signal, the precoding matrix, and an estimation of a channel condition between the network entity and a respective additional UE of the one or more other UEs,
wherein the imbalance compensation operation is performed based at least in part on an average of the first estimation and the respective additional estimations.

11. The apparatus of claim 10, wherein the first estimation and the respective additional estimations are averaged by assigning a weight to the first estimation and each of the respective additional estimations based at least in part on a quality metric.

12. The apparatus of claim 8, wherein the instructions are further executable by the processor to cause the apparatus to transmit, to the UE, an indication of the precoding matrix, wherein the precoding matrix is applied in the transmission chain of the network entity.

13. The apparatus of claim 8, wherein the instructions are further executable by the processor to cause the apparatus to:
transmit, to the UE, an indication that the UE is to estimate the frequency domain imbalance based at least in part on a default precoding matrix,
wherein the precoding matrix is the default precoding matrix.

14. The apparatus of claim 8, wherein the imbalance compensation operation is performed after applying the precoding matrix and before modulating the in-phase portion and the quadrature-phase portion.

15. The apparatus of claim 8, wherein the instructions are further executable by the processor to cause the apparatus to:
transmit an indication of a timing for generating the estimation of the frequency domain imbalance,
wherein the indication of the first estimation of the frequency domain imbalance is received in accordance with the timing.

16. A method for wireless communication at a user equipment (UE), comprising:
receiving, from a network entity, a reference signal;
transmitting, to the network entity, an indication of an estimation of a frequency domain imbalance between an in-phase portion of the reference signal and a quadrature-phase portion of the reference signal based at least in part on a precoding matrix associated with transmissions from the network entity and an estimation of one or more channel conditions between the UE and the network entity; and
receiving, from the network entity, a data transmission based at least in part on transmitting the indication of the estimation of the frequency domain imbalance.

17. The method of claim 16, wherein the reference signal is affected by the one or more channel conditions and the frequency domain imbalance, the method further comprising:
estimating a transmission signal associated with the data transmission, the transmission signal comprising the reference signal modified by the precoding matrix; and
performing an iterative frequency domain imbalance estimation process that generates the estimation of the frequency domain imbalance based at least in part on satisfaction of an estimation threshold.

18. The method of claim 17, wherein the iterative frequency domain imbalance estimation process comprises:
estimating the one or more channel conditions;
estimating, based at least in part on the one or more channel conditions and the transmission signal, the frequency domain imbalance;
applying a compensation parameter to the reference signal; and
determining whether a difference between the estimation of the frequency domain imbalance and the frequency domain imbalance satisfies the estimation threshold.

19. The method of claim 17, wherein the frequency domain imbalance is estimated by performing a least square estimation or a least minimum mean square error estimation, or any combination thereof.

20. The method of claim 16, further comprising receiving, from the network entity, an indication of the precoding matrix.

21. The method of claim 16, further comprising:
receiving, from the network entity, an indication that the UE is to estimate the frequency domain imbalance based at least in part on a default precoding matrix,
wherein the precoding matrix is the default precoding matrix.

22. The method of claim 16, further comprising:
receiving an indication of a timing for generating the estimation of the frequency domain imbalance,
wherein the estimation of the frequency domain imbalance is transmitted in accordance with the timing.

23. A method for wireless communication at a network entity, comprising:
transmitting, to a user equipment (UE), a reference signal;
receiving an indication of a first estimation of a frequency domain imbalance between an in-phase portion of a transmission chain of the network entity and a quadrature-phase portion of the transmission chain of the network entity, the first estimation being based at least in part on the reference signal, a precoding matrix associated with transmissions from the network entity, and an estimation of a channel between the UE and the network entity;
performing an imbalance compensation operation associated with the transmission chain of the network entity that balances the in-phase portion and the quadrature-phase portion of the transmission chain based at least in part on the first estimation of the frequency domain imbalance; and
transmitting, to the UE, a data transmission based at least in part on performing the imbalance compensation operation.

24. The method of claim 23, wherein the imbalance compensation operation comprises applying the first estimation of the frequency domain imbalance to a transmission signal associated with the data transmission.

25. The method of claim 23, further comprising:
receiving, from one or more other UEs, respective additional estimations of the frequency domain imbalance, each respective additional estimation being based at least in part on the reference signal, the precoding matrix, and an estimation of a channel condition between the network entity and a respective additional UE of the one or more other UEs,
wherein the imbalance compensation operation is performed based at least in part on an average of the first estimation and the respective additional estimations.

26. The method of claim 25, wherein the first estimation and the respective additional estimations are averaged by assigning a weight to the first estimation and each of the respective additional estimations based at least in part on a quality metric.

27. The method of claim 23, further comprising transmitting, to the UE, an indication of the precoding matrix, wherein the precoding matrix is applied in the transmission chain of the network entity.

28. The method of claim 23, further comprising:
transmitting, to the UE, an indication that the UE is to estimate the frequency domain imbalance based at least in part on a default precoding matrix,
wherein the precoding matrix is the default precoding matrix.

29. The method of claim 23, wherein the imbalance compensation operation is performed after applying the precoding matrix and before modulating the in-phase portion and the quadrature-phase portion.

30. The method of claim 23, further comprising:
transmitting an indication of a timing for generating the estimation of the frequency domain imbalance,
wherein the indication of the first estimation of the frequency domain imbalance is received in accordance with the timing.
